(19) United States
(12) Patent Application Publication
(10) Pub. No.: US 2003/0055754 A1
(43) Pub. Date: Mar. 20, 2003

(54) Method, system and computer program product for facilitating a tax transaction

(75) Inventor: Daniel L. Sullivan, Marblehead, MA (US)

Correspondence Address: PERKINS, SMITH & COHEN LLP, ONE BEACON STREET, 30TH FLOOR, BOSTON, MA, 02108, US

(73) Assignee: govONE Solutions, LP, Omaha, NE

(21) Appl. No.: 10/238,410

(22) Filed: Sep. 10, 2002

Related U.S. Application Data
(63) Continuation-in-part of application No. 10/169,250.
Application No. 10/169,250 is a continuation of application No. PCT/US00/42498, filed on Nov. 30, 2000.

(51) Int. Cl. G06F 17/60

(52) U.S. Cl. 705/31

(57) ABSTRACT

A transaction tax compliance system having a transaction tax compliance processor which receives transaction information from selling/purchasing input systems and returns, stores, and reports the tax liabilities caused by the transaction event.

### RELATED APPLICATIONS

This application claims priority under 35 U.S.C. §119 to U.S. Provisional Patent Application Serial No. 60/168,081 filed Nov. 30, 1999, the disclosure of which is incorporated herein by reference in its entirety. This application is a continuation-in-part of U.S. application Ser. No. ______ entitled, “Method, System, and Computer Program Products for Facilitating a Tax Transaction” filed ______ which is a continuation of PCT Application No. PCT/US00/42498 entitled Method, System, and Computer Program Products for Facilitating a Tax Transaction filed Nov. 30, 2000 by the present applicant.

### BACKGROUND OF THE INVENTION

This invention relates to a method, a system, and a computer program product for determining and reporting a transaction tax liability for a transaction involving the sale of products or services. The burden on sellers and buyers to comply with transaction tax laws and rules in all jurisdictions in which they do business is extraordinary, and is made complicated by the numerous taxes that may be applicable in each jurisdiction involved in the transaction. Some of these taxes are either not known or complied with by the sellers and buyers. For example, consummated transactions may be subject to many different tax schemes, including, but not limited to, customs, excise, sales, and use taxes, gross receipts taxes, utility taxes, business and occupation taxes, and value added taxes. Federal, state, and local governments around the world have the legal authority to enact transaction taxes, and tens of thousands of taxing jurisdictions are in place today.

Transaction tax liabilities related to the consummation of a transaction are typically calculated at the time of the transaction by the seller at the seller's location, even though the purchaser may be at a remote location. The seller collects the tax from the purchaser, and later remits it to the appropriate tax authority. The remittance is typically supported by a tax return that contains data sufficient to explain the calculation of that remittance. The seller is required to maintain its records relating to the transaction until the applicable statute of limitations has passed, and during that period typically uses that data to defend audits performed by tax authorities. To comply with legal obligations to collect and remit transaction taxes, sellers must at a minimum 1) maintain knowledge of applicable transaction tax laws and regulations everywhere they do business, 2) maintain the capacity to calculate the accurate transaction tax liability for all consummated transactions, and 3) account for those transaction taxes to the appropriate tax authority.

Conversely, in some cases vendors will not collect transaction taxes from a purchaser such as when the purchaser resides within a taxing jurisdiction where the vendor has no legal obligation to do so. In these instances, the purchaser is usually required to calculate and remit the transaction tax to the applicable tax authority, possibly an expensive administrative proposition for the purchaser.

### SUMMARY OF THE INVENTION

Transaction tax compliance burdens can be eased through application of a transaction tax compliance system that allows sellers or purchasers to calculate, record, and report the tax liabilities for transactions. Sellers and purchasers, through their billing or purchasing systems, cash registers, and/or web sites, may transmit transaction data to one or more centralized processors through telecommunications technology or via their own computer networks. The transaction tax compliance system thereafter calculates the appropriate tax liability for the transaction by determining at least one of the following: 1) whether a taxable event has occurred, 2) where the taxable event occurred, 3) whether the transaction is subject to standard or special transaction tax laws or rules, and 4) who is responsible for reporting and remitting the tax liability. The tax liability is then transmitted back to the input source of the transaction for application to a sales order, purchase order, invoice, e-commerce checkout screen, or other transaction documentation. The transaction tax compliance system also records the tax liability for use in completing a tax return, defending an audit, or tax planning.

The transaction tax compliance system includes data and formulae that allow for accurate transaction tax compliance. The system calculates the tax based on: 1) the applicable tax situs (the taxing location), 2) the applicable international, federal, state, and local tax rates and limitations, 3) product-and/or service-based exemptions (exemptions based upon the taxable status of a product or service), 4) entity-and/or use-based exemptions (exemptions based upon the taxable status of a purchaser or seller or upon the use to which the purchase will be put), and 5) the appropriate method of rounding. The system also imports the tax liability information into the applicable tax return; the returns can be completed and printed for execution and mailing. The automation of these functions substantially reduces the transaction tax compliance burdens sellers and purchasers suffer. Further, users no longer need to research and analyze transaction tax laws and rules, as it is included in the system.

The transaction tax compliance system may be linked to the banking network as well as to a computer systems used by tax authorities. This linkage would allow for the calculation, collection, recording, reporting, and remitting of a transaction tax liability through the transaction tax compliance system. Such a configuration would allow tax authorities to provide and monitor the transaction tax information applied by sellers and purchasers to an extent not possible today.

Various embodiments of the present invention provide certain advantages and overcome certain drawbacks of the conventional methods. This being said, the present invention provides numerous advantages including the above noted advantage of reducing the transaction tax compliance burden on a seller and purchaser.

Further features and advantages of the present invention are described in detail below with reference to the accompanying drawings.

### BRIEF DESCRIPTION OF THE DRAWINGS

Various embodiments of the invention will now be described, by way of example, with reference to the accompanying drawings, in which:

FIG. 1 is a data flow diagram of an example transaction tax compliance system of the present invention;

FIG. 2 is a diagram of an example transaction tax processor;

FIG. 3A is a diagram of an example table for a database of sellers;

FIG. 3B is an example user interface for seller/purchaser registration;

FIG. 3C is an example user interface for seller/purchaser registration;

FIG. 3D is an example user interface for seller/purchaser registration;

FIG. 3E is an example user interface for seller/purchaser registration;

FIG. 3F is an example user interface for seller/purchaser registration;

FIG. 4A is a diagram of an example table for a database of taxable transaction information;

FIG. 4B is a diagram of an example table for a database of purchasers;

FIG. 5A is a diagram of an example table for a database of exempted products/services;

FIG. 5B is a diagram of an example table for a database of exempted entities/uses;

FIG. 5C is a diagram of an example table for a database of address data;

FIG. 6 is a diagram of an example table for a database of tax liability information;

FIG. 7 is a diagram of an example table for a database of standard tax rates;

FIG. 8 is a flow chart describing how a transaction tax liability and compliance is determined in one embodiment;

FIG. 9 is a flow chart describing how sellers/purchasers may be registered for access to the tax transaction processor;

FIG. 10 is a flow chart describing how a transaction may be initialized;

FIG. 11 is a flow chart describing how addresses may be managed;

FIG. 12 is a flow chart describing how the tax situs, tax type, and tax rate may be determined;

FIG. 13 is a flow chart describing how purchasers, sellers, products, and/or uses of a product may be exempted from tax in a transaction;

FIG. 14 is a flow chart describing how the applicable tax liability may be calculated;

FIG. 15A is a flow chart describing how transaction information is processed;

FIG. 15B is an example interface for communicating tax liability information to the selling/purchasing system;

FIG. 16 is a block diagram illustrating a relationship between processes corresponding to the flow chart of FIG. 8, and the databases of FIGS. 3A-7, in one embodiment;

FIG. 17 is a flow chart of the general operation of a business transaction system including transaction tax compliance system;

FIG. 18 is a flow chart of the operation of the money management and reconciliation module of the streamlined sales tax system;

FIG. 19 is an example transaction and tax report for Merchant A according to principles of the present invention;

FIG. 20 is an example transaction and tax report for Merchant B according to principles of the present invention;

FIG. 21 is an example transaction and tax report for Merchant C according to principles of the present invention;

FIG. 22 is an example transaction and tax report for Merchant D according to principles of the present invention;

FIG. 23 is an example report of total taxes owed to a selection of states by merchants according to principles of the invention;

FIG. 24A, FIG. 24B, FIG. 24C are sample reports illustrating financial flow among merchants, states and the tax system according to principles of the invention; and

FIG. 25 is a sample summary report to the tax system and its partners according to principles of the invention.

### DETAILED DESCRIPTION

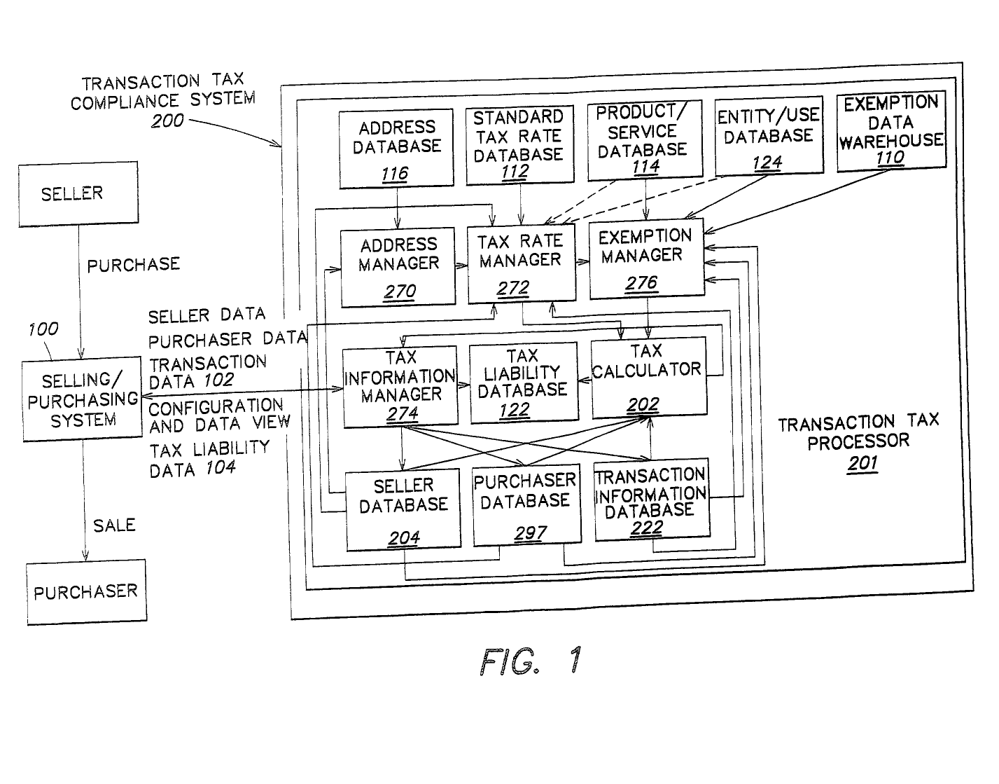

FIG. 1 illustrates an example transaction tax compliance system 200 for facilitating the calculation, recording, and reporting of a transaction tax liability of a transaction. A taxable transaction is regulated and taxed by an appropriate taxing authority in an appropriate taxable jurisdiction. The transaction may be a public or private transfer in which goods or services of a seller may be sold to one or more purchasers. There are many kinds of taxable transactions as determined by the extensive laws and regulations of different tax authorities in different tax jurisdictions including, but not limited to, international, federal, state, and local jurisdictions. The applicable taxes may include, but are not limited to, custom, excise, use, sales, gross receipts, utility, business and occupation, and value added taxes.

The transaction tax compliance system preferably includes a tax transaction calculator 202, an address manager 270, a tax rate manager 272, an exemption manager 276, and a tax information manager 274, all of which may be present and operating on one or more computers or other devices acting as a server computer for the transaction. Although the functions/processes of the transaction tax compliance system are described in a particular order, the various operations need not be performed sequentially or in the order described.

The processor computer, herein called a transaction tax processor 201, may be accessed by one or more computers or other devices used by sellers or purchasers in any manner known in the art (e.g., via the Internet).

Users, including sellers and/or purchasers, of the transaction tax compliance system preferably first configure records of the transaction tax compliance system according to their business. The selling/purchasing system 100 is interconnected to the transaction tax processor 201 through one or more computers, devices, and/or interfaces used by sellers and purchasers in any manner known in the art, including the Internet and server protocols and devices. The transaction information manager 274 may then be accessed from the selling/purchasing system 100 remote or separate location with a communication system, which in one embodiment is a typical Internet browser. For example, a user may access an applicable logon web page by inputting the applicable URL.

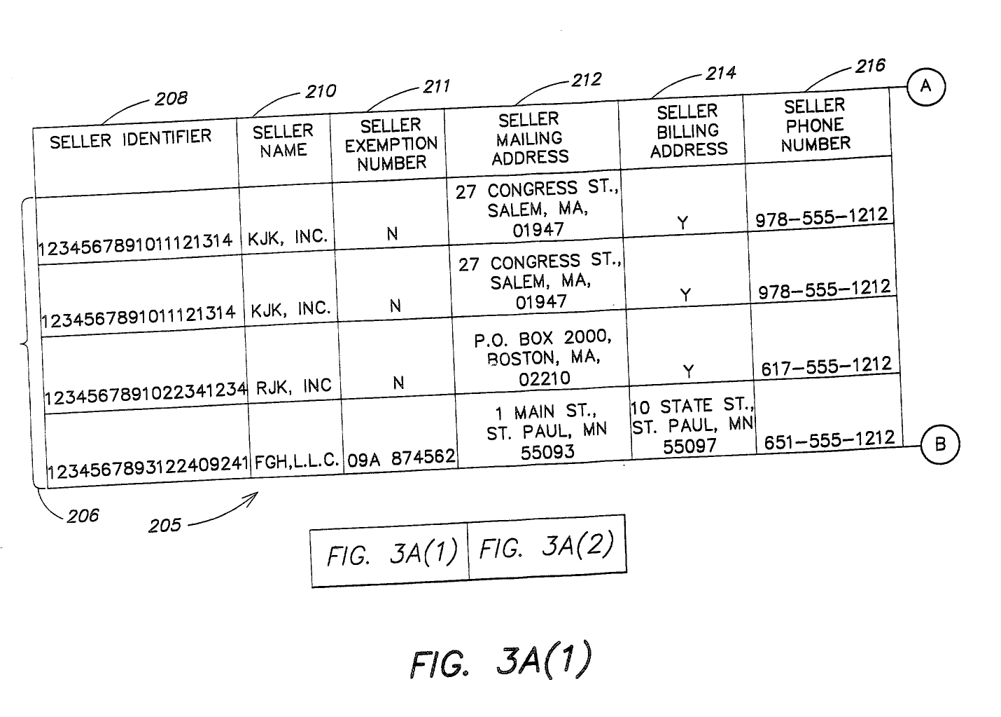

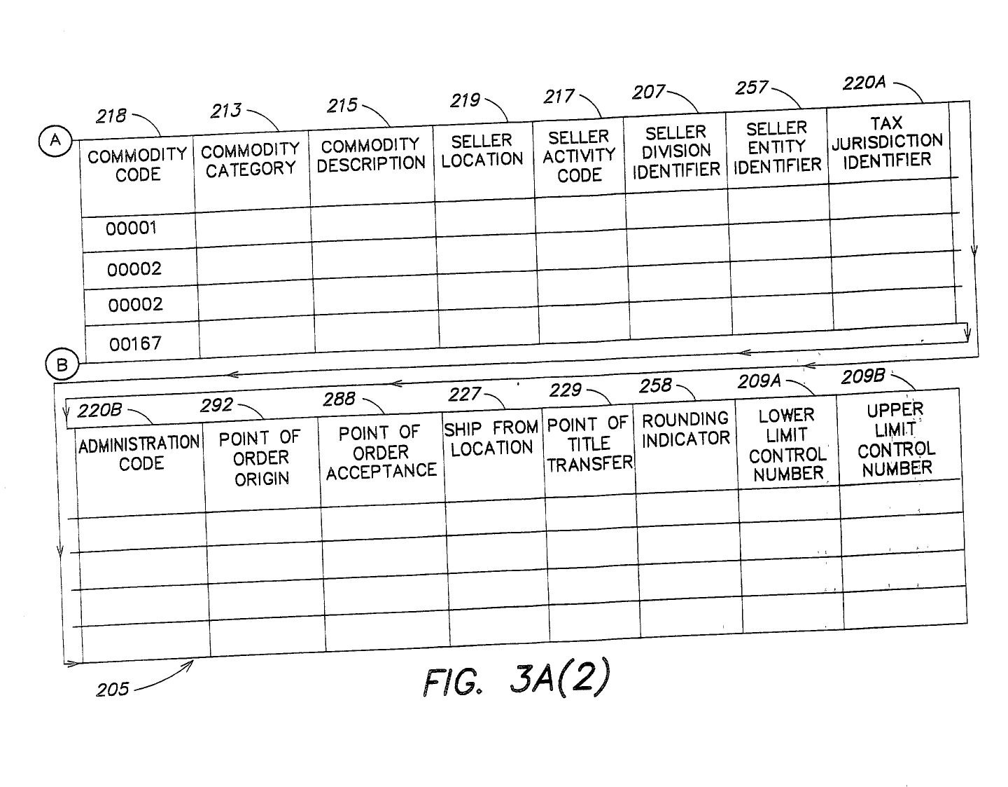

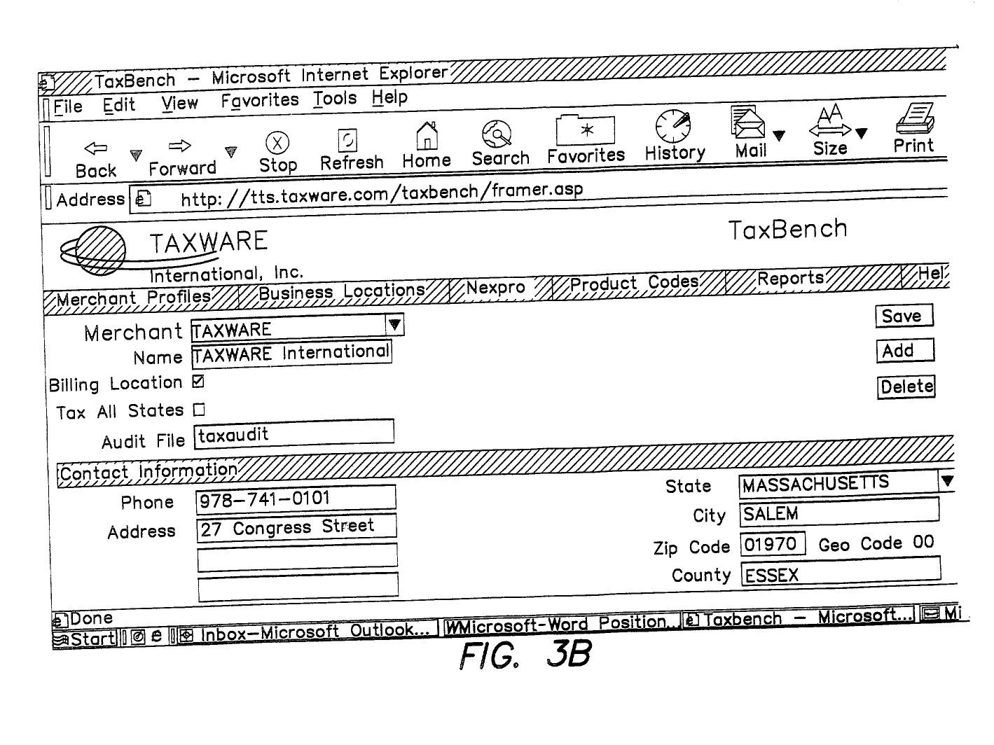

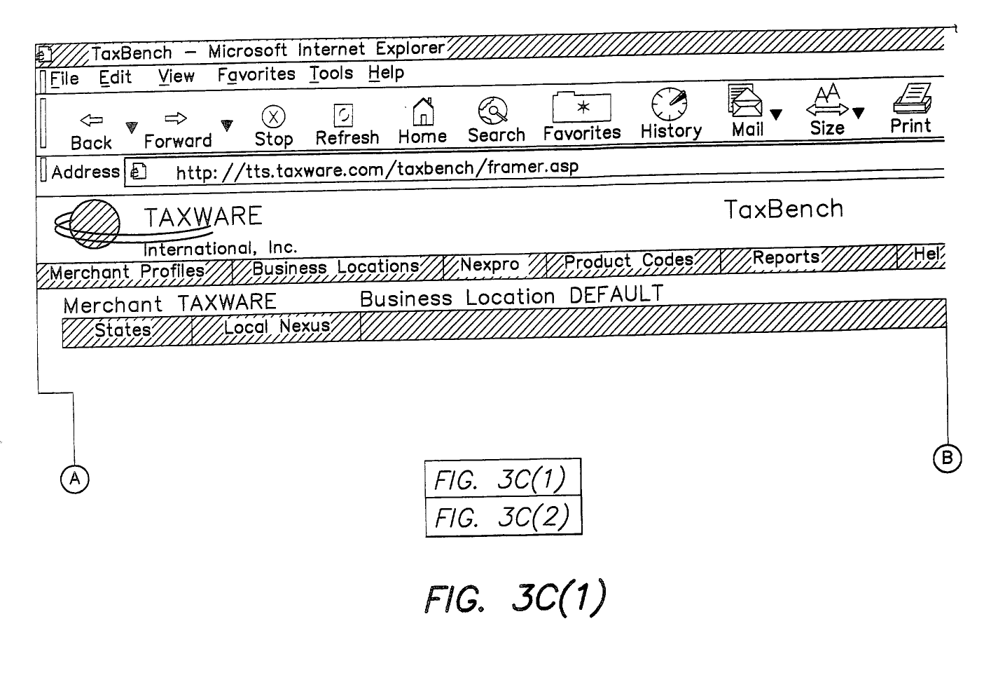

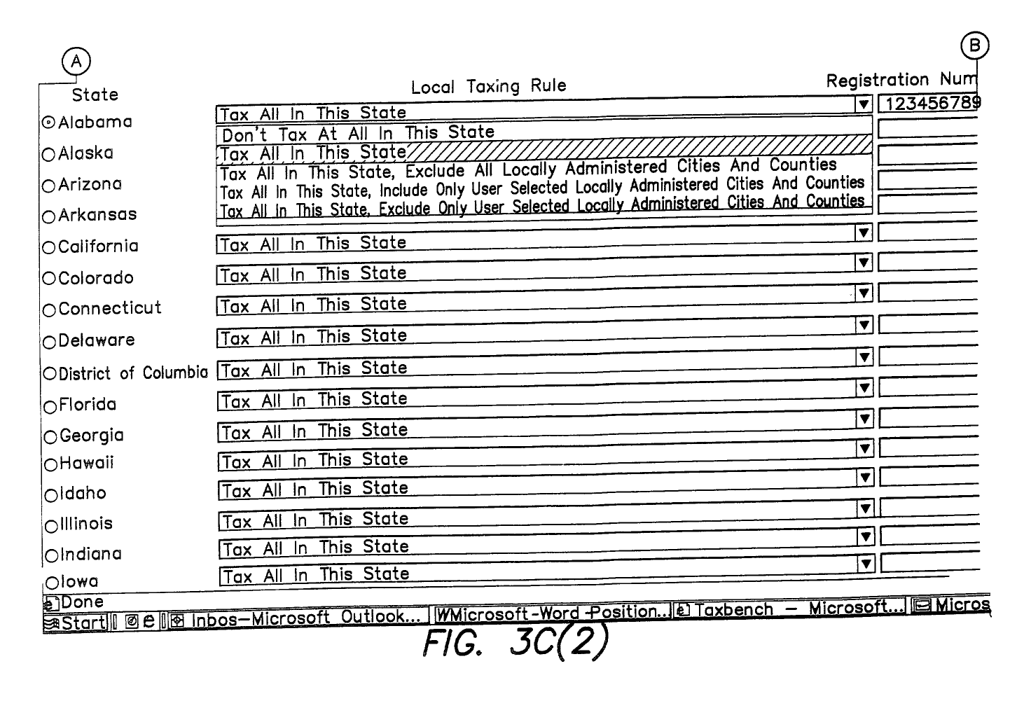

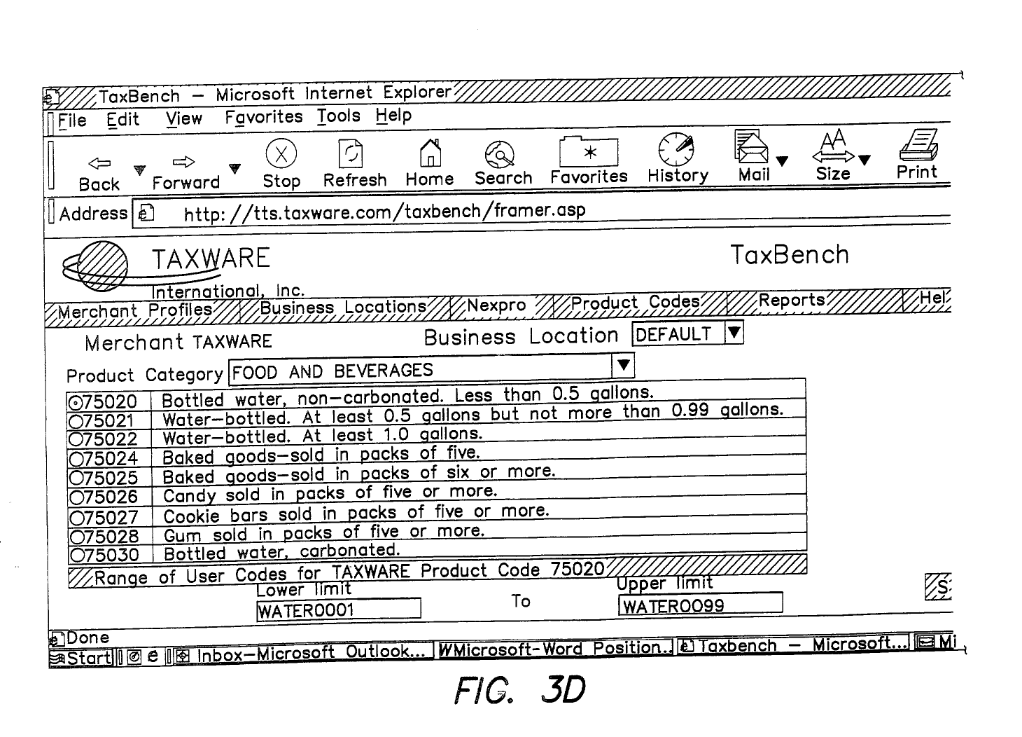

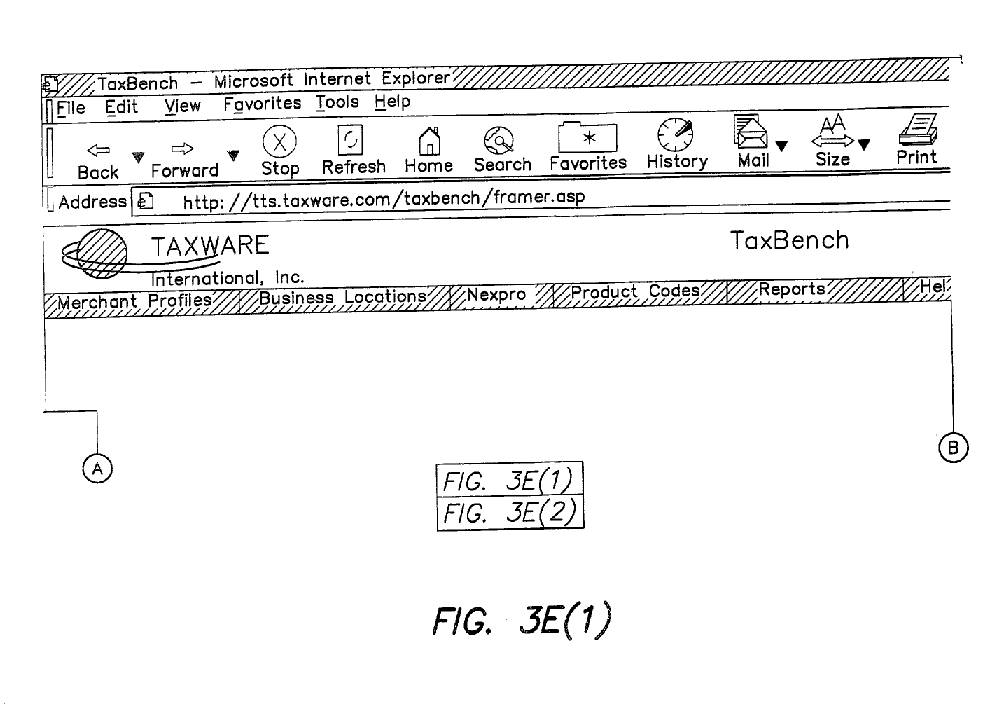

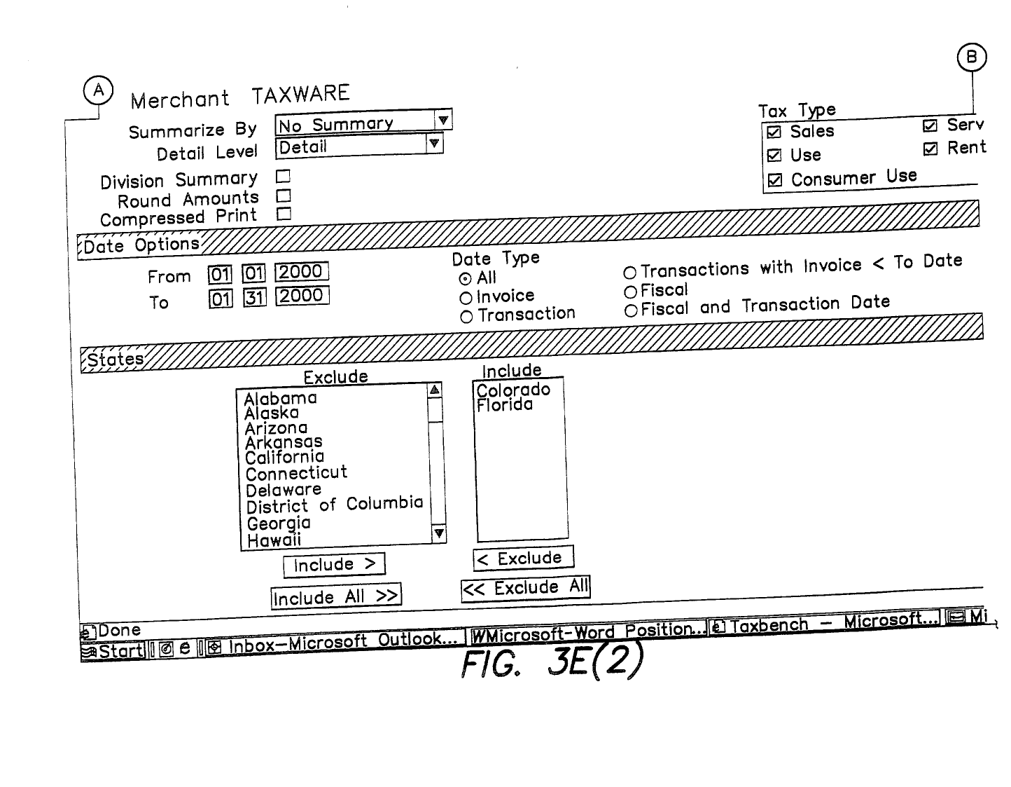

The user of the transaction tax compliance system 200 then inputs a username and password to proceed. Users of the transaction tax compliance system 200 may thereafter 1) enter or edit contact information (e.g., the name of the person authorized to access the transaction tax compliance system 200) and company information, including, company divisions and entities, 2) input business locations (warehouses, sales offices, showrooms, headquarters, etc.) and identify the status of those locations, 3) identify tax collection obligations, 4) identify taxpayer registration numbers, 5) attach catalog control numbers (“SKU's”) representing products or services that they sell or purchase to an applicable commodity code of the transaction tax compliance system, 6) identify exempt entities, as well as the reasons for those exemptions, and/or 7) identify exempt uses for the products or services that they purchase. The seller/purchaser information may be transmitted by the selling/purchasing system 100 in any number of ways, including, but not limited to, any data or signal discernable by the transaction tax compliance system 200 as seller and/or purchaser data, such as a message in any format of any computer protocol. For example, any suitable interface, such as an HTML form as shown in FIGS. 3B-3F, may be used to permit a user of the transaction tax compliance system 200 to create or update seller/purchaser information. This may take place well before the user of the transaction tax compliance system 200 initializes any transactions, may occur as part of a transaction, and/or may occur in real-time.

The contact information may be a name, security code, password, title, or other unique identifier of the contact information. The business location identifier may be any data or signal indicative of a unique identifier, such as an address, location code, location description, or other unique identifier of the location, status, and/or type of business location. The tax collection obligations may be any data or signal indicative of a unique identifier, such as an address, geographical location identifier, jurisdiction identifier, administration code, or other unique identifier of the tax collection obligations. The taxpayer registration number may be any data or signal indicative of a unique identifier, such as a license number, registration number, name, or other unique identifier of the taxpayer registration. The catalog control numbers and commodity codes may be any data or signal indicative of the product or service category or type, such as a numerical code, description, commodity type identifier, or other unique identifier of the commodity type or category. The entity exemption identifier may be any data or signal indicative of a unique identifier, such as an exemption certificate number, a license number, a description of the reason for the exemption, or other unique identifier of the exemption status based on an entity. The use exemption identifier may be any data or signal indicative of a unique identifier, such as an exemption certificate number a license number, a description of the reason for the exemption, or other unique identifier of the exemption status based on a reason. The transaction tax compliance system 200 stores this information in a seller database 204 and/or a purchaser database 297.

After the user configures the transaction tax compliance system 200, the user's selling/purchasing system 100 may send transaction data 102 for one or more transactions to the transaction tax processor 201. The transaction data 102 may be automatically or manually transmitted by the selling/purchasing system 100 in any number of ways, including, but not limited to, any data or signal discernable by the transaction tax compliance system 200 as transaction data, such as a message in any format of any computer communication protocol.

To determine the tax liability and calculate the appropriate tax liability for the transaction, the tax transaction system 200 generally uses the minimum amount of information necessary. In many cases, the applicable transaction tax liability can be extrapolated from 1) the date of the transaction, 2) the sales or purchase price of the product or service sold or purchased (the indication of the transaction amount may be any data or signal indicative of a unique identifier, such as a numerical amount of the gross amount of sale by invoice total or by line item or the amount of tax charged, or other unique identifier of the transaction amount), and 3) the physical locations involved in the transaction (the ship-from location, the ship-to location, the location where the purchaser's invoice is mailed, the location where the order was first recorded, and the location where the order was contractually accepted by the seller, and the location of title transfer; these locations may be identified as any data or signals indicative of the unique identifiers, such as street number, street name, city name, state code or province name, and zip code, location code, or other unique identifier of the location. If multiple data options are available, the transaction information may also include any data or signal indicative of appropriate flags identifying the data type transferred, including, but not limited to, numerical amount identifier (gross or tax amount) gross amount identifier (item or invoice total), and credit identifier (identifying a negative tax liability).

In other cases, the applicable transaction tax liability cannot be determined without 1) a commodity code which defines the taxable status of a product or service (the indication of the product or service type may be any data or signal indicative of the unique identifier, such as a name, type, or other unique identifier of the product or service type); 2) a reason code which identifies exempt entities (the indication of the status of the purchaser or the seller may be any data or signal indicative of a unique identifier, such as a name, reason code, purchaser or seller exemption number, or other unique identifier of the purchaser or the seller) or uses (the indication of the use to which the purchase will be put may be any data or signal indicative of a unique identifier, such as a name, use code, explanation, status code, or other unique identifier of the use); or 3) taxpayer registration numbers of the seller and/or purchaser. Any information that the transaction tax compliance system 200 can infer or determine independent of input from the seller and/or the purchaser may be omitted from the submitted transaction data. Additionally, transaction information may also include an exempt amount with jurisdiction identifier, contract amount, installation amount, freight amount, discount amount, number of items, rounding identifier indicating the scheme for rounding dollar amounts less than $0.01, tax type identifier (including based on sales or use), no tax indicator, override amount and jurisdiction, invoice date, purchaser identifier, purchaser name, invoice number, invoice line item number, delivery date, seller/purchaser company code, seller identifier, seller name, and seller/purchaser division codes.

The transaction tax compliance system 200 performs tax compliance and/or calculates the applicable transaction tax liability in essentially “real-time.” Real-time is defined as during the transaction, beginning with the selling/purchasing system initiating a transaction with the transaction tax compliance system and ending with the purchasing/selling system finalizing the transaction by authorization, payment, or canceling the transaction. The transaction tax compliance system may further determine the applicable tax liability by using “real-time processing”. Real-time processing occurs when there is no substantial (it could be 8-10 seconds) discernable time between the placing of an order and the finalization of the order. For example, an over-the-counter transaction may apply real-time processing: a cash register (seller system 100) may transmit transaction data 102 to the transaction tax processor 201, and the tax liability may be presented to the user of the selling/purchasing system. The selling/purchasing system may also receive the applicable tax liability from the transaction tax compliance system in real-time. The selling/purchasing system 100 may automatically or manually access a transaction tax compliance system from its remote location and send the appropriate transaction data. The selling/purchasing system may then manually or automatically receive the applicable tax liability as determined by the transaction tax compliance system.

Additionally or alternatively, the transaction tax processor 201 may compute applicable tax liabilities for a group of transactions that the selling/purchasing system 100 amassed over a given period of time. An invoice run, in which all invoices for transactions consummated during a given time period are processed en masse, is an example of this method of processing. A real-time computation and or real-time processing of the applicable tax may be applied to any of the above discussed individual and batch modes in many transaction types including over-the-counter credit card transactions, Internet transactions (retail), Internet transactions (business to business), remote transactions with a hand-held computer platform, laptop or desktop computer, or on-site sales. The transaction tax processor may also determine a negative tax liability, such as when processing a credit invoice. Like a transaction, the selling/purchasing system may transfer a gross dollar amount of the transaction (reversed regular invoice) or may override the tax calculation and pass a tax liability credit (invoice summary credit).

The transaction tax compliance system 200 records tax liability data for each transaction. The information about each transaction typically includes at least the transaction data required to calculate and report the applicable tax liability, and optionally any other transaction, seller and/or purchaser, information, and/or status of the transaction or completion status. Other information about the transaction also may be provided. Users of the transaction tax compliance system 200 may manually or automatically access the transaction data and/or the appropriate tax liability by requesting the information from the transaction tax processor 201, by reading the information from some storage location maintained by the transaction tax processor 201, by the transaction tax processor 201 sending the information to the user, and/or in any other manner appropriate given the implementation of the transaction tax compliance system 200 and the selling/purchasing system 100.

An address manager 270 may extrapolate the applicable taxing jurisdictions from particular address data of a seller, purchaser, and/or transaction. The possible locations include, for example, ship from location, ship to location, billing location, location where the order was first recorded, location where the order was contractually accepted by the seller, and/or location of title passage. The address manager may analyze the street address (street number, street name, city name, state code or province name, and zip code) and assign at least one applicable tax location code associated with that address. The taxing jurisdiction code(s), for a particular address location, may identify the taxing jurisdiction(s) within which the location sits. This process may be performed by comparing the address information submitted by the selling/purchasing system 100 to address information in address database 116. More specifically, the transaction tax compliance system may access address data from the address database to be compared to the address data to determine the applicable taxing jurisdiction code. The address manager may receive information from the address database in any number of ways, including, but not limited to, any data or signal discernable by the transaction tax processor as address data, such as a message in any format of any computer protocol. The address manager may access the address database by requesting the information from the host system for the address database, by the address database sending the information to the transaction tax compliance system, or in any other manner appropriate given the implementation of the transaction tax processor and the address database.

The address data may be any data or signal indicative of a unique identifier, such as street address, city, county, state or province, country, or zip code. The taxing jurisdiction code may be any data or signal indicative of a unique identifier of a tax jurisdiction, such as an address, a jurisdiction identifier, or any unique identifier of the tax location. The address database may be maintained by one or more of the transaction tax processor 201 and any third party. The transaction tax compliance system 200 may determine possible tax jurisdictions in real-time and further, using real-time processing. The transaction tax compliance system 200 may manually assign taxing jurisdiction codes or may assign taxing jurisdiction codes only after authorization from the selling/purchasing system 100, or alternatively, may automatically assign taxing jurisdiction codes when calculating the appropriate tax for a transaction. The transaction tax compliance system may then update tax location data in the seller database and/or transaction information database.

The tax rate manager 272 may serve many functions including, but not limited to: 1) determining the tax situs (the location of the taxable event), 2) determining the tax type, and 3) determining the applicable tax rate(s). The tax rate manager 272 may determine the tax situs by accepting a selling/purchasing system designated tax situs or by examining the taxing jurisdiction codes from the address manager and/or the mailing addresses of 1) the place to which a purchased, leased or rented good is shipped, 2) the place where a service is performed, 3) the place from which a purchased, leased or rented product is shipped, 4) the place where an order for a product or service is first recorded, 5) the place where an order for a product or service is contractually approved by the seller, 6) the location where the purchaser of the product or service is invoiced (the bill to location) and/or 7) the location of title passage according to a rule database that associates a particular address and address type with a taxability situs. The tax rate manager may stop processing the transaction if the information given is incomplete or may select a “most likely” location based on factors including largest population. The tax rate manager may also indicate an error message to indicate the incomplete or determined information.

The tax rate manager 272 may also determine the tax type applicable to the transaction (sales, use, excise, etc.) by accepting a selling/purchasing system designated tax type or by comparing the same taxing jurisdiction codes from the address manager and/or the addresses used to determine the tax situs with a rule database which associates a transaction type with a tax type. The applicable tax rate(s) may be specified by the selling/purchasing system or retrieved from a standard tax rate database 112 which associates a tax rate with a tax situs and a tax type. The tax situs, tax type, and standard tax rate database 112 may be updated and/or maintained by one or more of the transaction tax compliance system 200 or any third party. The tax situs, tax type, and tax rate database may be manually or automatically updated periodically or as tax laws change in accordance with methods known in the art including electronic data transfer, CD updates or replacement data, and manual input such as through a keyboard.

The tax rate manager 272 may receive information from the tax situs database, tax type database, and standard tax rate database 112 in any number of ways, including, but not limited to, any data or signal discernable by the tax rate manager as tax situs, tax type, and/or tax rate data, such as a message in any format of any computer protocol. The tax rate manager 272 may access the tax situs database, tax type database, and/or tax rate database 112 by requesting the information from the system hosting the database, or by the database sending the information to the tax rate manager 272, or in any other manner appropriate given the implementation of the tax rate manager 272 and the tax situs database, tax type database, and/or tax rate database 112.

The tax situs may be any data or signal indicative of a tax situs, including a jurisdiction identifier, a state code, a zip code, a city identifier, a county identifier, a geographical location code, or any other unique identifier of a tax situs. The tax type may be any data or signal indicative of a tax type, including an identifier, description or any other unique identifier of at least one tax type, including, but not limited to, customs taxes, excise taxes, sales taxes, use taxes, gross receipts taxes, utility taxes, business and occupation taxes, and value added taxes. The tax rate may be any data or signal indicative of a tax rate, including a percentage, a code, or other unique identifier of a tax rate. The tax rate manager 272 may determine the tax situs, tax type, and/or applicable tax rate(s) in real-time, and further, may use real-time processing. The tax rate manager 272 may manually determine the tax situs, tax type, and/or applicable tax rate(s) only after authorization from the selling/purchasing system 100, or alternatively, may automatically determine the tax situs, tax type, and/or applicable tax rate(s) when a transaction is initialized.

After determining the tax situs, tax type, and standard tax rate(s), an exemption manager 276 may determine whether the transaction should be wholly or partially exempt. The exemption manager 276 may determine tax liability exemption in many ways, including receiving exempt transaction amounts, receiving a no-tax indicator from the seller/purchaser, or comparing the commodity codes in the transaction data 102 to data in the product/service database 114 and comparing the reason codes in the transaction data to data in the entity/use database 124. The exemption manager 276 may also compare the seller and buyer identifiers in the transaction data 102 with the entity/use database to determine whether the user of the transaction tax compliance system 200 has assigned a wholly or partially exempt status to the use of a product or the purchaser or seller with involved in the transaction.

The exemption identifier may indicate that the exemption manager may exempt the whole transaction, may exempt the whole transaction from a particular level of taxes, e.g., for a particular jurisdiction level such as local taxes, or may exempt part of the transaction by indicating a tax certificate number, a product exemption, or an exempt amount. Thus, the seller/purchaser may “turn off” taxation in certain jurisdictions, e.g., in states where the seller is not registered or should not be taxed; or certain customers, commodities, or uses may be actually exempt from taxation. For example, exemptions may include location-based thresholds (i.e., $2,500 maximum taxable amount); exempt products and services (i.e., clothing, food); exempt uses (i.e., sales to resellers); and exempt seller and/or purchaser entities (i.e., sales to charitable organizations). Similarly, the entity/use database allows sellers to implement exemptions based upon receipt of a direct pay or exemption certificate. The commodity code may be any data or signal indicative of a tax status of a product or service, including a unique identifier or description, or other unique identifier of a commodity code. Typical commodity codes may wholly or partially exempt food for human consumption, prescription drugs, sales of services, utility services, and/or freight charges.

The reason code may be any unique identifier of the tax status of a seller, a purchaser, and/or a specified use of a product, including, a seller exemption identifier, a use identifier, a purchaser exemption identifier, an exemption certificate number, a tax license number, or any other unique identifier for tax status. Typical reason codes may identify exempt sales of items to be resold in a taxable transaction, sales of machinery to be used in industrial processing, manufacturing, or farming; and/or sales of items to religious, nonprofit, charitable, or educational organizations. The exemption manager may determine any tax exemptions in real-time, and further, may use real-time processing. The exemption manager may manually determine the whole or partial exempt status of a transaction only after authorization from the selling/purchasing system 100, or alternatively, may automatically determine the whole or partial exempt status or for a transaction when a transaction is initialized.

The exemption amount or rate may be specified by the selling/purchasing system or alternatively may be determined from the product/service database, the entity/use database, and/or the standard tax rate database. The exempted amount and/or rate may indicate item and/or line item threshold amounts and limitations. Further, invoice thresholds and limitations may be indicated. Partial exemptions (e.g., special rates) and thresholds (i.e., base as reductions) may be implemented through exempt transactions amounts, transaction rates, and/or a rule system applicable to a calculation of the applicable tax liability. The exemption manager may access the seller and purchaser databases to retrieve administration codes to determine active and/or inactive tax jurisdictions and/or tax types as indicated by the seller and/or purchaser.

The product/service database and the entity/use database may be maintained by one or more of the transaction tax compliance system or any third party. The exemption manager may receive information from the product/service database and the entity/use database in any number of ways, including, but not limited to, any data or signal discernable by the exemption manager as exemption data, such as a message in any format of any computer protocol. The exemption manager may access the product/service database or the entity/use database by requesting the information from the system hosting the product/service database and/or the entity/use database, or by the product/service database and/or the entity/use database sending the information to the exemption manager, or in any other manner appropriate given the implementation of the exemption manager, the product/service database, and/or the entity/use database.

The transaction tax compliance system 200, through an exemption manager 276, may communicate with or access a tax exemption warehouse 110 maintained by the tax transaction processor or a third party to verify any tax exemption status for a particular commodity, purchaser, seller, or use. More specifically, the transaction tax compliance system may compare the purchaser name and tax exemption indicator to data from the tax exemption warehouse to verify the status of the purchaser as exempt from taxation. Similarly, the transaction tax compliance system may verify the tax exemption status of a seller, a product/service, or use of the product. The exemption manager may receive information from the tax exemption warehouse in any number of ways, including, but not limited to, any data or signal discernable by the transaction tax processor as exemption data, such as a message in any format of any computer protocol. The exemption manager may access the exemption data warehouse by requesting the information from the host system for the exemption warehouse, by the exemption warehouse sending the information to the tax transaction system, or in any other manner appropriate given the implementation of the transaction tax processor and the exemption data warehouse.

The transaction tax compliance system may determine tax exemption and/or verify tax exemption in real-time, and further, may use real-time processing. The transaction tax compliance system may manually determine tax exemption and/or verify tax exemption only after authorization from the seller system 100, or alternatively, may automatically determine and/or verify tax exemption when determining the appropriate tax liability for a transaction.

The tax calculator 202 applies the results obtained by the tax rate manager 272, the exemption manager 276, the seller database 204, and the purchaser database 297 to the transaction data 102, and calculates the applicable tax liability 104. The tax calculator may receive the tax situs information, the tax type, the applicable tax rates, the exemption information, the seller information, the purchaser information, and the transaction data in any number of ways, including, but not limited to any data or signal discernable by the tax calculator as tax calculation data, such as a message in any format of any computer protocol. The tax calculator may access the tax calculation data from the exemption manager, the tax rate manager, the seller database, the purchaser database, the transaction information database, and/or any other applicable database or process by requesting the information from the system hosting the requested information, by the process or database sending the information to the tax calculator, or in any other manner appropriate given the implementation of the tax calculator and the transaction tax processor. The determined tax liability may be any data or signal indicative of a tax liability, including a unique identifier or description, an amount, a percentage of the transaction amount, or other unique identifier of a tax liability amount. The tax calculator may determine any tax liability in real-time, and further, may use real-time processing. The tax calculator may manually determine the tax liability of a seller, purchaser, and/or transaction only after authorization from the selling/purchasing system 100, or alternatively, may automatically determine the tax liability when a transaction is initialized.

The tax liability 104, and optionally additional transactional data, may thereafter be transmitted to the selling/purchasing system 100, and/or stored in the tax liability database 122. The tax liability database may be maintained by one or more of the transaction tax compliance system or any third party.

Purchaser privacy may be maintained by retaining only the purchaser taxing jurisdiction code in the tax liability information database file to verify the taxing location. Fully taxable transactions require a review of the purchaser's mailing or billing addresses, but only a purchaser's taxing jurisdiction code may be stored in the tax liability information database file. Purchasers' names and street address information will not be retained.

If the transaction is partially or fully tax exempt, the tax liability information database file may retain additional information including, but not limited to, the commodity code assigned to the product or service based on the status of the product or service (e.g., food), the reason code based on the purchaser or seller status as an exempt entity or transaction status based on exempt use, and the exemption identification number based on the existing exemption certificate number. Purchaser privacy may be maintained by withholding the true identity of the purchaser, despite the non-taxable status of the transaction. If the exemption is due to the status of the product or service purchase, the commodity code assigned to the product or service is stored in the tax liability information database file. If the transaction is exempt due to the purchaser's status as an exempt entity, or if the transaction is exempt because the purchase will be put to an exempt use, the applicable reason code is retained to support the exemption using the transaction tax compliance system. The transaction tax compliance system may store an exemption identifier and the reason code in the tax liability information database file, but the tax liability information database system is not provided with the true identity of the holder of the exemption identifier.

After calculating the appropriate tax amount, a tax information manager 274 may forward the tax liability amount and any tax information to the selling/purchasing system. The tax liability information may be any data or signal indicative of the taxable transaction provided by the seller, the purchaser, the transaction tax compliance system, and/or any third party system. The information in the tax liability database may include purchaser identifier 254, transaction identifier 237, jurisdiction identifier 220A, commodity code 218, commodity code 218, applied tax rates 370 and/or over ridden tax rates for a particular jurisdiction, credit identifier 350, job number 374 indicating a particular business activity assigned by the selling/purchasing system such as a manufacturing line, purchaser name 226, basis amount (gross less exempt amounts) in a particular jurisdiction 372, date of order 294, date of transaction 296 indicating the date of the actual transaction or taxable event, invoice date 360 indicating the date the invoice is generated, jurisdiction location/address 322, ship to address 248, ship from address 227, point of order acceptance 288, point of order origin 292, point of title passage 229, seller identifier 208, and seller business location code 217. The tax information manager may also forward information at periodic times, when certain threshold levels are met, when specifically authorized, in real-time, and/or using real-time processing.

The user of the transaction tax compliance system 200 can use the tax information manager 274 to view, print, and/or download the information in the tax liability database 122. The data in the tax liability database 122 can also be downloaded into a software application that places the applicable tax liability data into the correct space on the applicable transaction tax return.

The transaction tax compliance system may be used with many types of selling/purchasing systems, including, but not limited to cash registers, computer platforms, order/billing systems, hand help computing platforms, and credit card transaction processing devices. In one embodiment of the invention, a credit card system may be associated with the transaction tax compliance system to calculate taxation of petroleum transportation fuels, as well as determine applicable exemptions. The system may function within existing credit card transaction processing environments. The transaction system credit maybe used to purchase fuels at participating merchant locations and may pay for the purchase with the transaction tax credit card. The cost of the transaction is inclusive of all applicable taxes. The transaction information may be sent through the credit card network to the transaction tax compliance system remote server location. The transaction tax compliance system then determines if the user is exempt from any of the taxes paid at the pump. The transaction tax compliance system may determine the exemptions by determining whether the type of fuel (gas or diesel) is exempt, whether the purchaser is exempt, whether the seller (the oil company) will file for the exemption on behalf of the purchaser, and whether the issuing bank will file for the exemption on behalf of the purchaser. When the purchaser receives the credit statement, the statement may be billed net of the exempt tax. The refund may be recovered by the oil company or the card issuing bank from the applicable tax authority, based on the tax exempt amounts calculated and reported by the transaction tax compliance system. The transaction tax compliance system may store and retain all tax liability data for tax reporting and audit purposes.

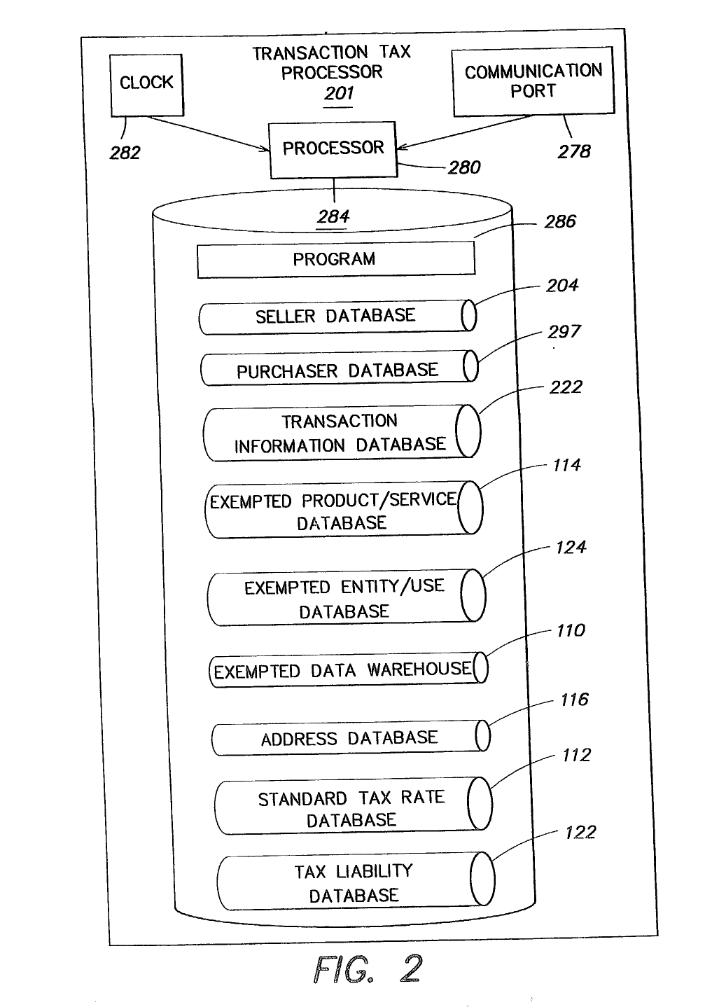

An example implementation of a transaction tax compliance system will now be described in connection with FIGS. 2-7.

The transaction tax processor 201, shown in FIG. 2, may include one or more communication ports 278, one or more processors 280, an internal data and time clock 282, and storage 284 which includes one or more computer programs 286 defining instructions, which once executed, instruct the computer to perform the operations of the transaction tax calculator, address manager, tax rate manager, exemption manager, and tax information manager. The storage may also include a seller database 204, a purchaser database 297, a transaction information database 222, an exempt entity/use database 124, an exempt product/service database 114, an address database 116, a standard tax rate database 112, a tax liability database 122, and any other databases applicable to calculating appropriate tax liabilities. These programs and these databases will now be described in more detail in connection with FIGS. 3A-7.

FIG. 3A illustrates an example table 205 for a seller database, which includes one or more records 206. In general, each record associates a seller identifier 208 with a commodity code 218 and tax jurisdiction identifier 220A, and optionally, additional information about the identified seller. In this example, each record 206 includes a seller identifier 208, seller name 210, seller exemption number 211, seller mailing address 212, seller billing address 214, seller phone number 216, commodity code 218, tax jurisdiction 220A, administration code 22013, seller location 219, seller location activity code 217 (warehouse, sales, showroom, headquarters, manufacturing), point of order origin 221A, ship from location 221B, point of order acceptance location 221C, point of order origin 292, point of order acceptance 288, ship from location 227, point of title passage 229, commodity category 213, commodity description 215, seller division identifier 207, seller entity identifier 257, and a rounding indicator 258 (establishing a method of rounding amounts less than $0.01). The administration code 220B may indicate to the transaction tax compliance system whether the purchaser or seller has an obligation to collect, and therefore calculate, report and remit, transaction tax liabilities that arise in a taxing jurisdiction. Division codes 207 may be used to indicate or identify a particular division of a multidivisional company or may be used to identify particular product lines or other information. The seller system may associate the seller SKU or catalog control number with an appropriate commodity code 218, for example, through a lower limit of seller catalog control number 209A and an upper limit of seller catalog control number 209B. Entries in this database are made as sellers register with the transaction tax processor as described above. After a seller registers with the transaction tax processor, seller information, including commodity code designations, business locations, and administration codes may be added or modified by the seller.

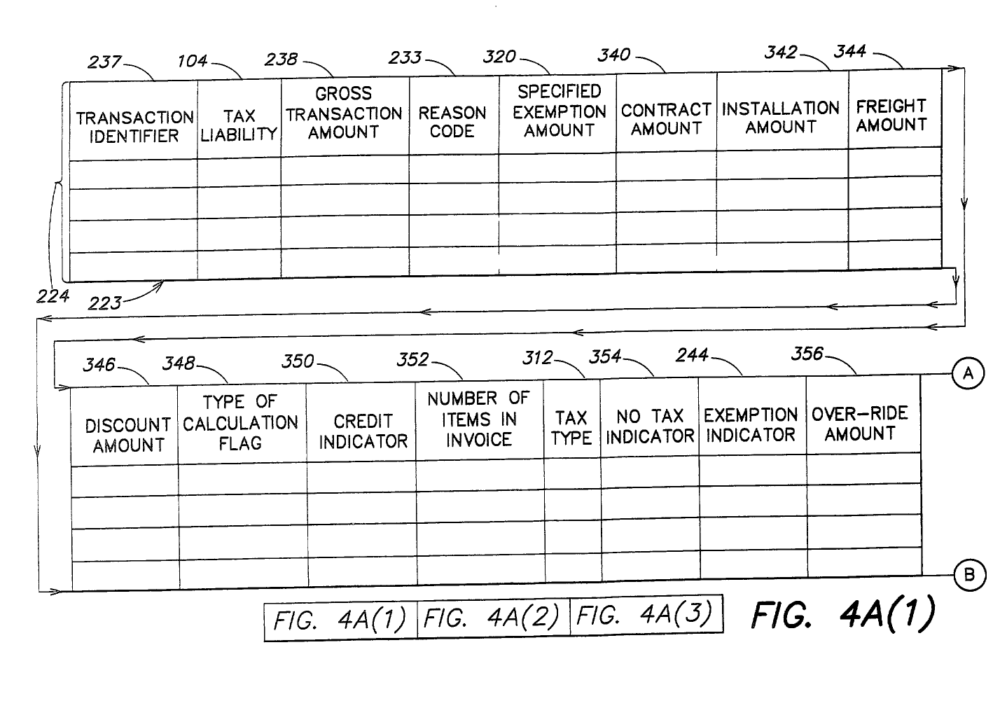

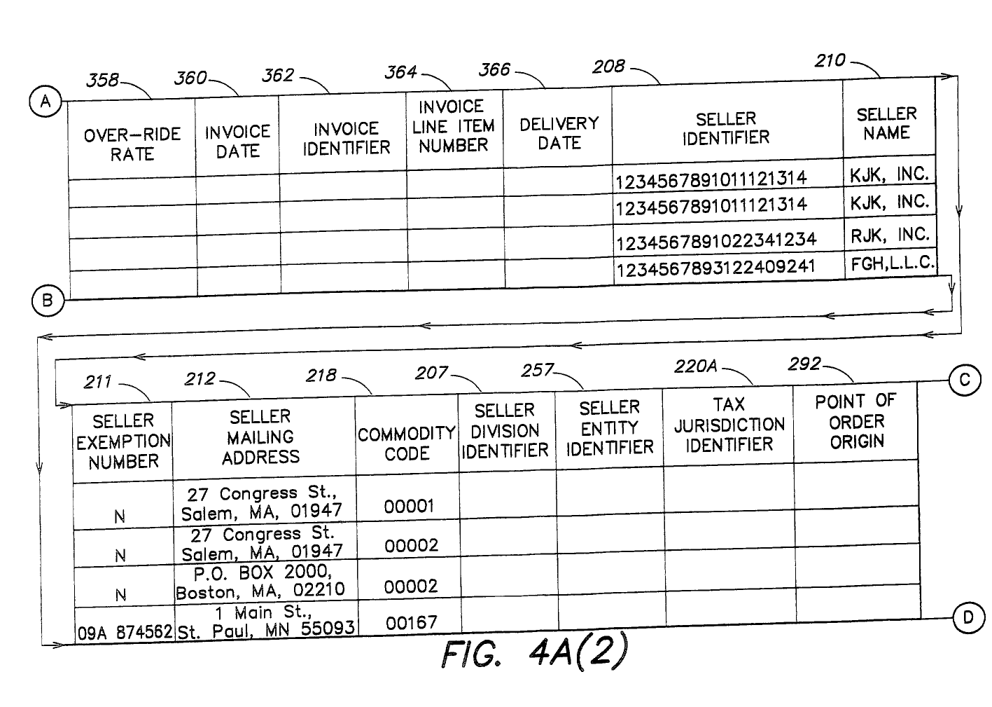

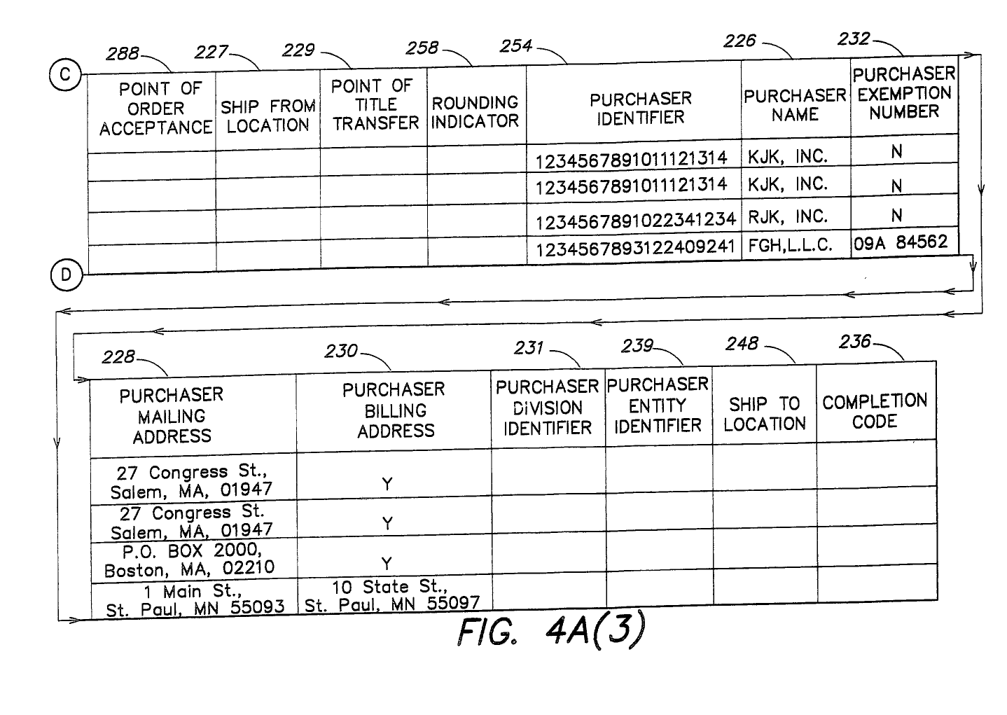

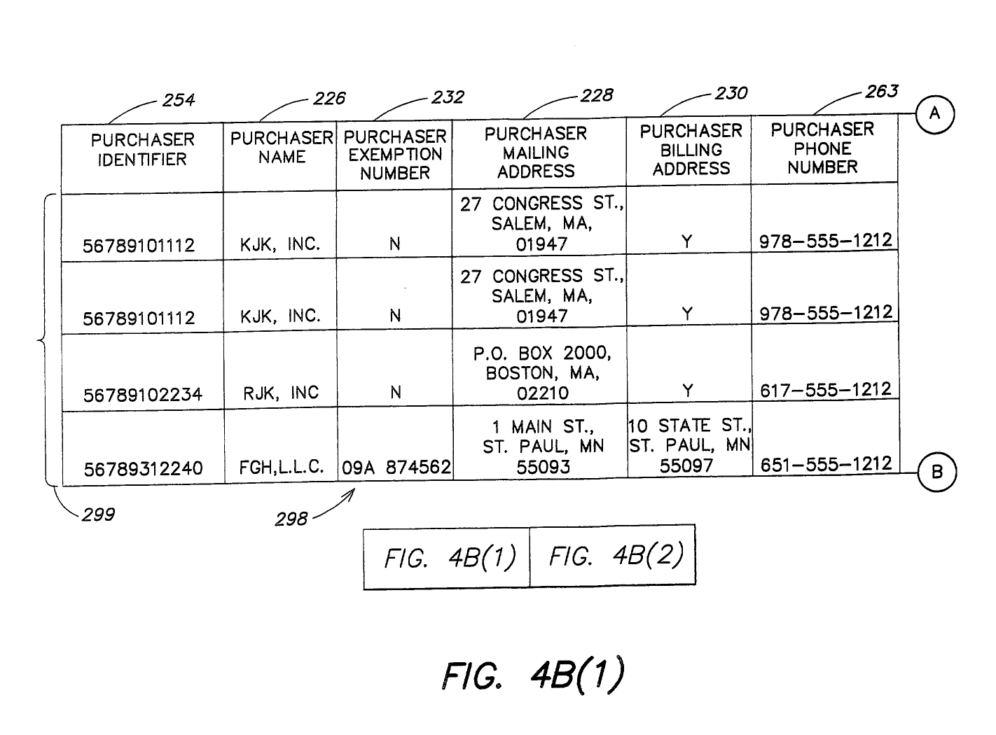

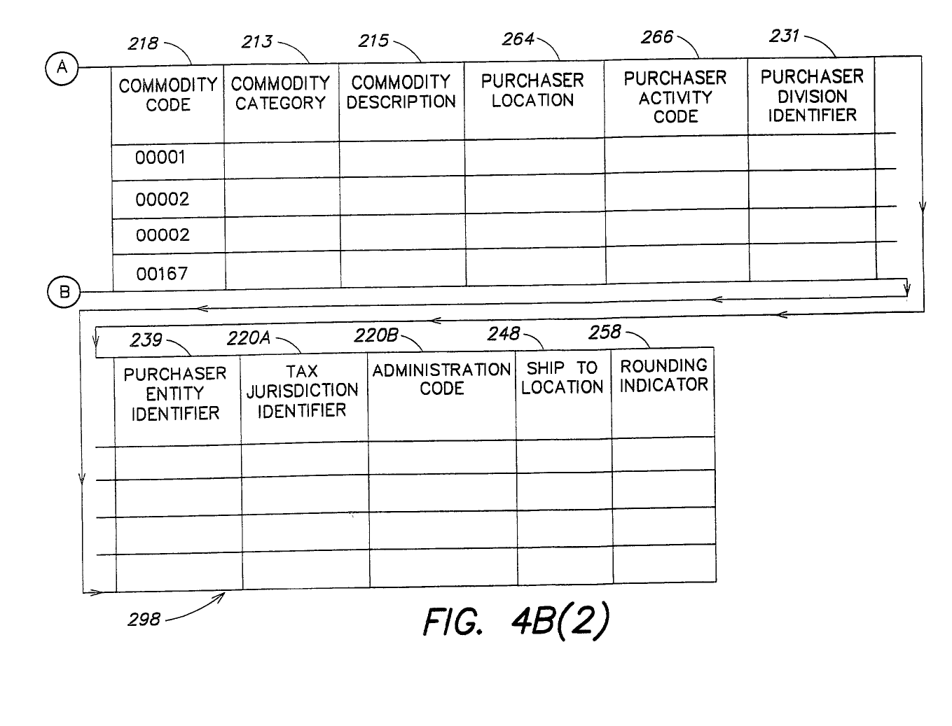

FIG. 4B illustrates an example table 298 for a purchaser database, which includes one or more records 299. In general, each record associates the purchaser identifier 254 with commodity code 218 and tax jurisdiction identifier 220A, and optionally, additional information about the identified purchaser. In this example, each record 299 includes a purchaser identifier 254, purchaser name 226, purchaser exemption number 232, purchaser mailing address 228, purchaser billing address 230, purchaser phone number 263, commodity code 218, tax jurisdiction 220A, administration code 220B, purchaser location 264, purchaser location activity code 266 (warehouse, sales, showroom, headquarters, manufacturing), shipping address 221D, ship to location 248, commodity category 213, commodity description 215, purchaser division identifier 231, purchaser entity identifier 239, and a rounding indicator 258 (establishing a method of rounding amounts less than $0.01). The administrative code 220B may indicate to the transaction tax compliance system whether and how to calculate tax liability amounts in a particular jurisdiction and/or for a tax type, similar to seller administration codes discussed above. Division codes may be used to indicate or identify a particular division of a multidivisional company or may be used to identify particular product lines or other information. The purchaser system may associate the product SKU or catalog control number with an appropriate commodity code 218, for example through a lower limit of seller catalog control number 209A and an upper limit of seller catalog control number 209B. Entries in this database may be made as purchasers register with the transaction tax processor similar to that described above with reference to seller registration. Alternatively and/or additionally, purchasers may register individually for each individual transaction either through the seller system or directly with the transaction tax system. After a purchaser registers with the transaction tax processor, purchaser information may be added or modified by the purchaser and/or the seller.

Any suitable interface, such as an HTML form similar to that used for seller registration as shown in FIGS. 3B-3F, may be used to permit a purchaser to register with the transaction tax compliance system. Additionally, or alternatively, the seller system may also maintain a purchaser database for use with future purchases.

FIG. 4A illustrates an example table 223 for a transaction information database, which includes one or more records 224. In general, each record associates a transaction identifier 237, a tax jurisdiction identifier 220A, the tax liability 104, the gross transaction amount 238 (invoice total or line item), and optionally, additional information about the purchaser, the seller, the product, and/or the transaction. Example additional information about the purchaser and seller includes the purchaser identifier 254, the purchaser name 226, the purchaser mailing address 228, the purchaser billing address 230, the shipping address 248, the purchaser exemption identifier 232, the seller exemption identifier 211 seller division code 207, seller location code 217, seller entity code 257, purchaser division code 231, purchaser location code 266, purchaser entity code 239, and the reason code 233 indicating an entity based exemption or the stated use of the product by the purchaser. Example additional information about the product and transaction includes commodity code 218, gross transaction amount 238, specified exemption amount 320 for a particular jurisdiction, contract amount 340, seller mailing address 212, seller ID 208, seller name 210, installation amount 342, freight amount 344, discount amount 346, type of calculation flag 348 (what amount passed), credit indicator 350, number of items in invoice 352, rounding indicator 258, tax type used for a particular jurisdiction (sales, use, etc.) 312, no tax indicator for a particular jurisdiction 354, exempt indicator for a particular jurisdiction 244, over-ride amount in a particular jurisdiction 356, over-ride rate in a particular jurisdiction 358, invoice date 360, invoice identifier 362, invoice line item number 364, delivery date 366, ship from address 227, point of title passage 229, point of order origin 292, point of order acceptance 288, and completion code 236. In lieu of gross amount of sale 238, the selling/purchasing system may pass the amount of tax charged, and the transaction tax processor calculates the gross taxable amount. Entries in this database are made and updated as the selling/purchasing systems request the applicable tax liability amount from the transaction tax processor, as described below.

The completion code for each transaction may indicate successful calculation of tax liability, indicate a special situation (such as seller over-ride or system default), indicate a potential problem and questionable tax amounts, or indicate a problem such that the transaction tax compliance system was unable to calculate tax amount, including indicating incomplete transaction information such as invalid location code or no gross amount, no seller database on file, invalid tax calculation type, error in accessing a database, exempt amount greater than gross plus freight, tax amount or freight amount generate basis amount exceeding field size, adjustments, per maximum tax laws, specified taxes not calculated, and seller over-ride indicated. The transaction tax compliance system may also return an additional completion code for jurisdiction determination, for example, indicating successful jurisdiction determination, indicating invalid entry and default, indicating invalid entry and stop processing.

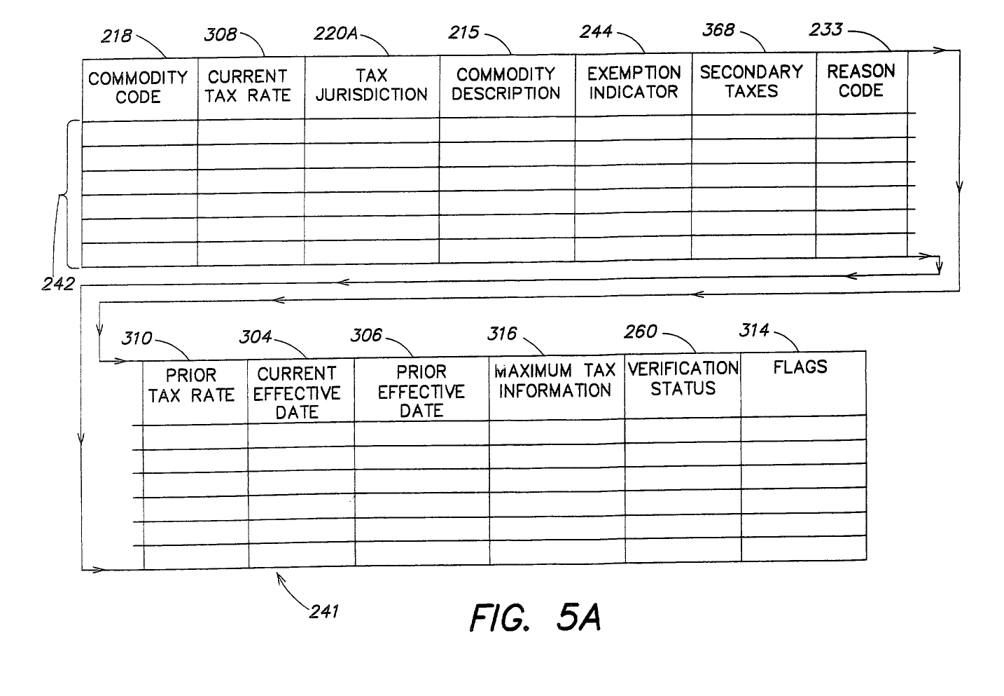

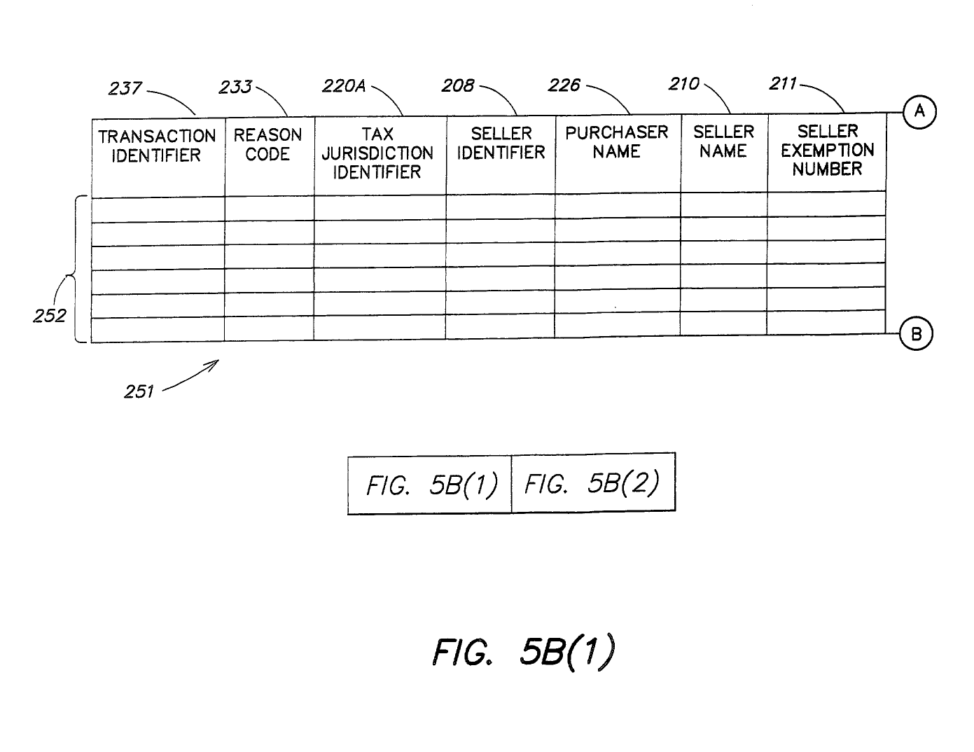

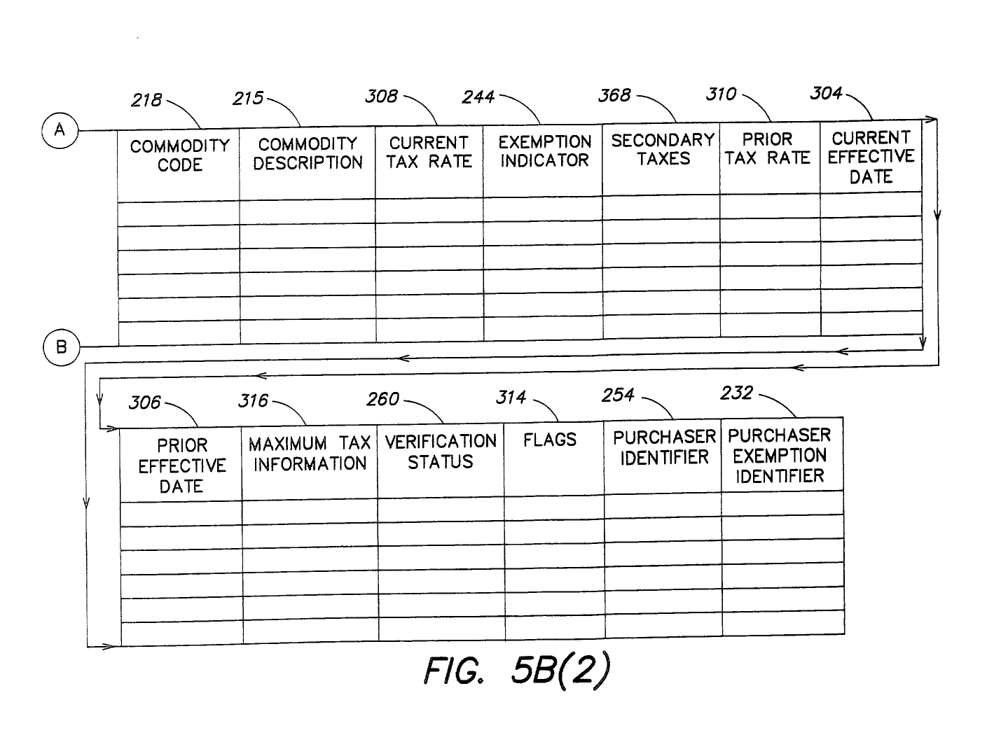

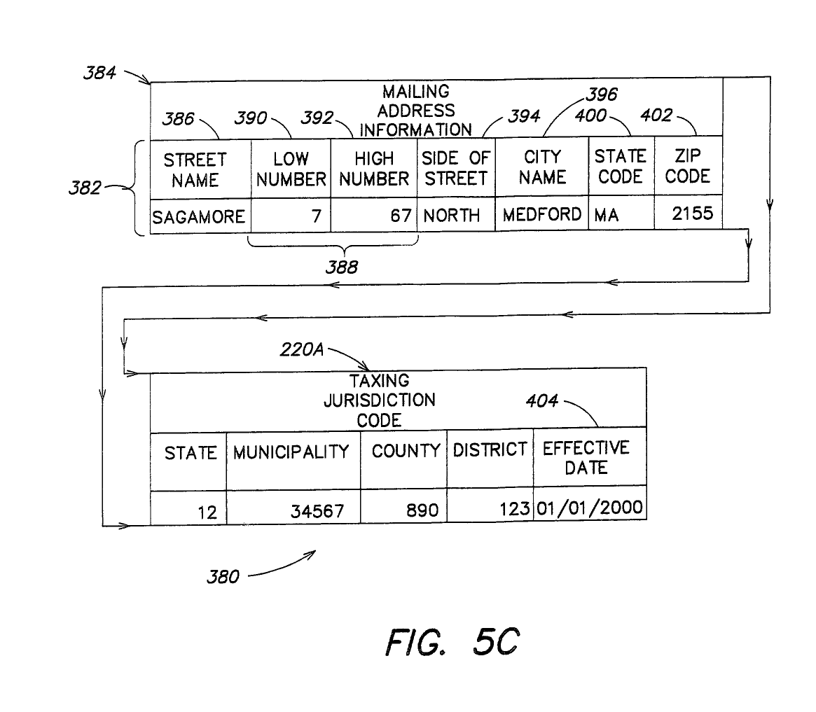

FIG. 5A illustrates an example table 241 of a database of exempted products/services, which includes one or more records 242. In general, each record associates a commodity category 213 with a commodity code 218 with a current tax rate 308 in a particular tax jurisdiction 220A and optionally additional information such as a commodity description 215, exemption indicator for a particular jurisdiction 244, secondary taxes 368, reason code 233 identifying an exempted use, prior tax rate for the location 310, prior effective date 306, effective date for the current tax rate 304, maximum tax information 316 (current and prior maximum tax amounts, current and prior maximum taxable amounts, current and prior maximum rates, current maximum effective date, current and prior maximum tax code to determine which fields are applicable and tax calculation logic to use), and verification status 260. The product/services database may also include flags 314 indicating maximum tax flag; jurisdiction flag which may determine if the location of the rate in a jurisdiction is located in a commodity code record, a standard tax rate file, or exempt from taxes and tax type; and any rules and/or instructions to calculate commodity tax liability in applicable jurisdictions. Entries in this database are made and updated by the transaction tax processor to maintain compliance with taxing laws and regulations in tax jurisdictions.

FIG. 5B illustrates an example table 251 for an exempted entity/use database, which includes one or more records 252. In general, each record associates a transaction identifier 237 with a reason code for a particular tax jurisdiction 220A and optionally additional information such as purchaser identifier 254, seller identifier 208, purchaser name 226, seller name 210, purchaser exemption number 232, seller exemption number 211, applicable commodity codes 218, commodity description 215, a current tax rate 308 in a particular tax jurisdiction 220A, exemption indicator for a particular jurisdiction 244, secondary taxes 368, reason code 233 identifying an exempted purchaser/seller/use, prior tax rate for the location 310, current effective date 304, prior effective date 306, maximum tax information 316 (current and prior maximum tax amounts, current and prior maximum taxable amounts, current and prior maximum rates, current maximum effective date, current and prior maximum tax code to determine which fields are applicable and tax calculation logic to use), verification status 260, and flags 314 including those described above with reference to the product/service database.

Entries in this database are made and updated as selling/purchasing systems register with the transaction tax compliance system and as a transaction is initialized in the transaction tax processor to determine the applicable tax liability of the transaction. The verification status 260 may be created and updated by the tax transaction processor after verifying the exemption identifier for a particular tax jurisdiction as described below and the exemption indicator 244 may be created and updated after determining and/or verifying the exemption status as described below.

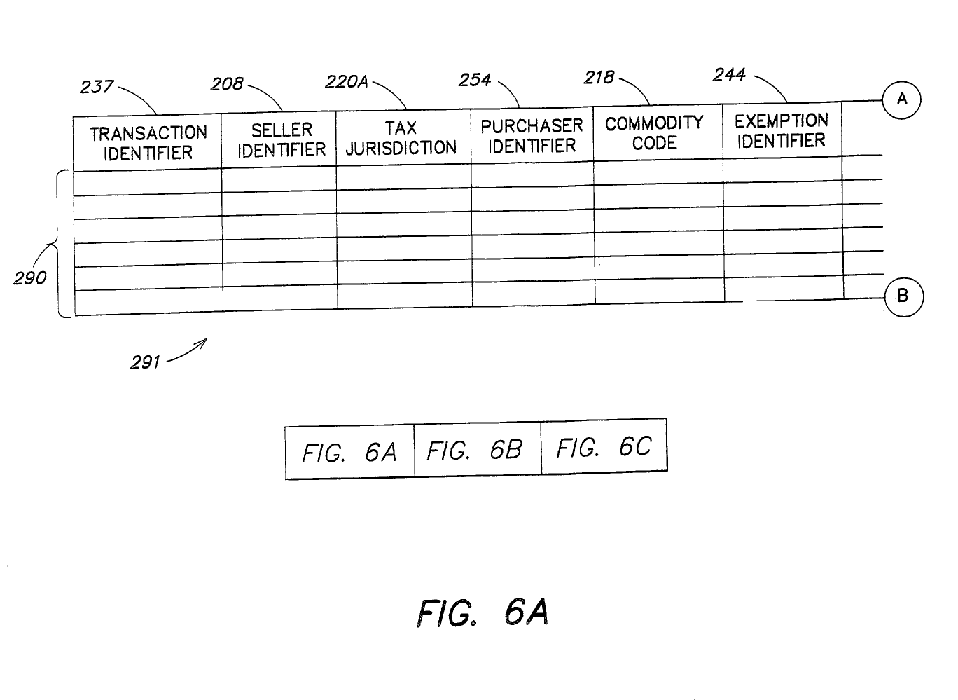

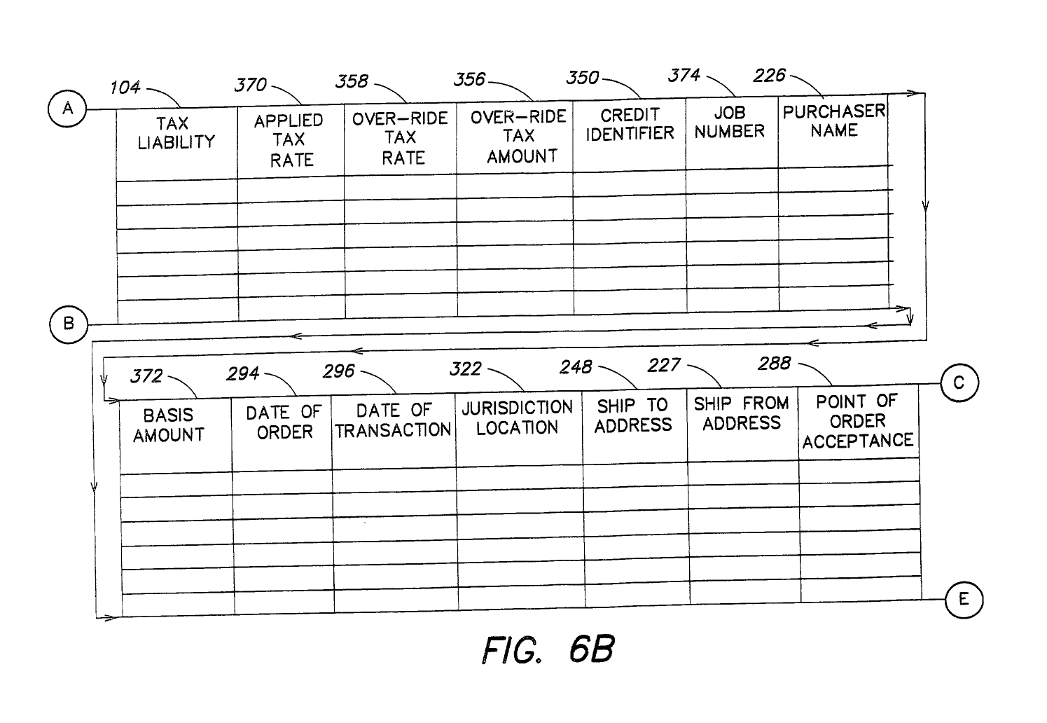

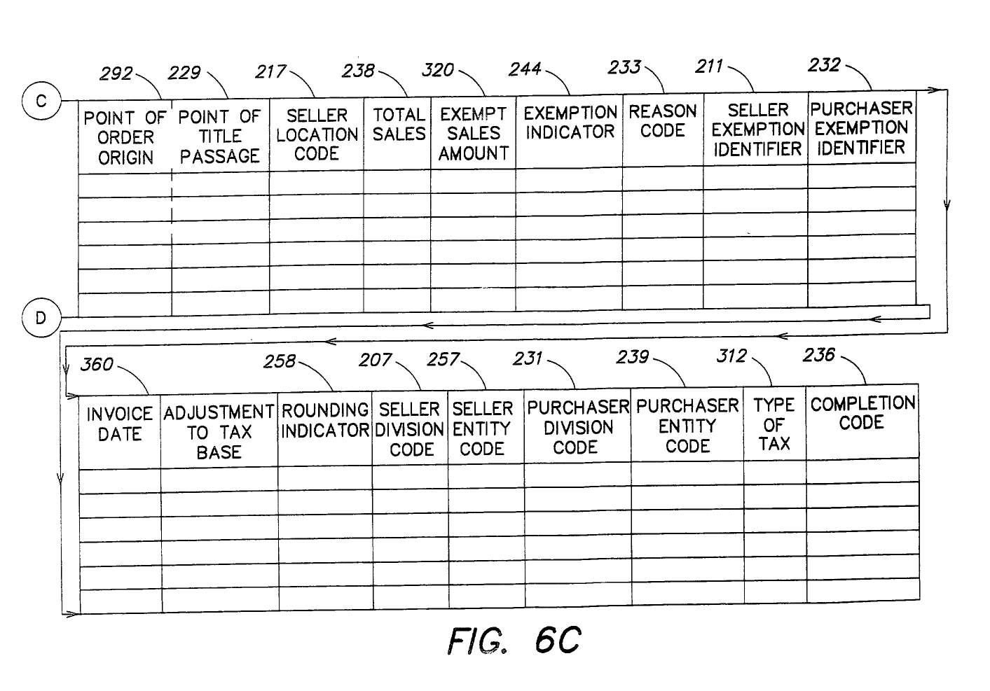

FIG. 6 illustrates an example table 291 from a tax liability database. This database stores information about present and past transactions. In the example shown in FIG. 6, a record 290 may include a transaction identifier 237, seller identifier 208, tax jurisdiction 220A, purchaser identifier 254, commodity code 218, exemption identifier 244, a calculated tax liability 104, applied tax rate 370, overridden tax rate 358, overridden tax amount 356, job number 374, purchaser name 226, basis amount (gross less exempt amounts) 372, date of order 294, date of transaction 296, jurisdiction location 322, ship to address 248, ship from address 227, point of order acceptance 288, point of order origin 292, point of title passage 229, seller business location code 217, total sales (gross sales amount) 238, exempt sales amount 320, exemption indicator (use, product, entity) 244, reason code 233, seller exemption identifier 211, purchaser exemption to the tax base (bad debt write-offs, identifier 232, invoice date 360 and/or adjustments returns, repossessions, etc.), rounding indicator 258 and/or express collection or ‘breakage’ (the amount collected in excess of the amount actually due, e.g. fractions of pennies), seller division code 207, seller entity code 257, purchaser division code 231, purchaser entity code 239, type of tax 312, and completion code 236. Entries in this database are made and updated by the transaction tax processor as transactions are started and completed.

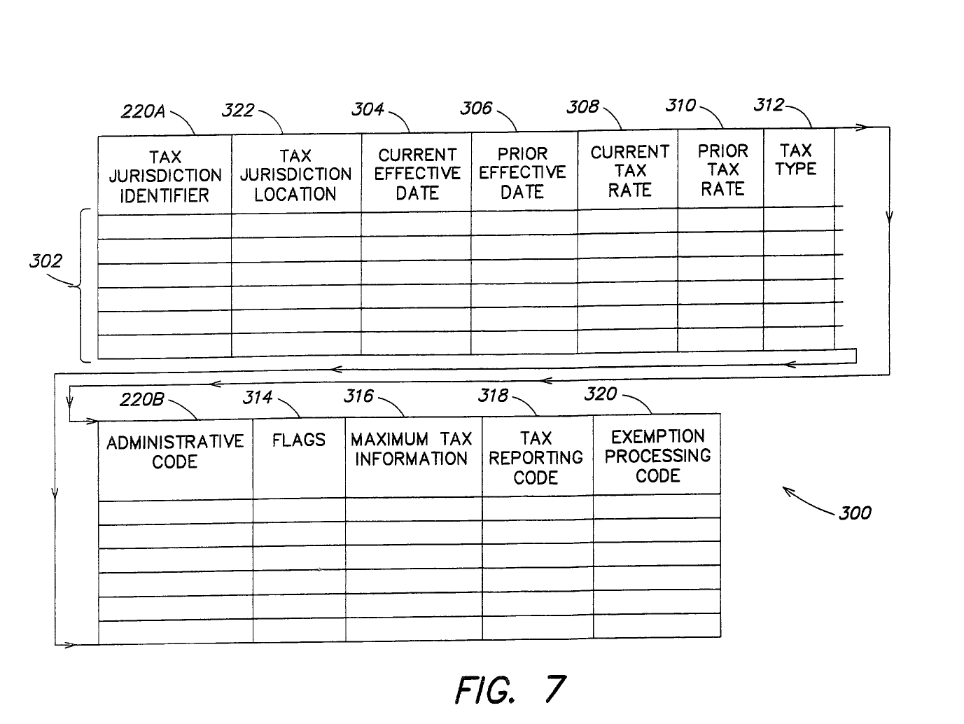

FIG. 7 illustrates an example table 300 from a standard tax rate database. This database stores information about present and past tax rates. In the example shown in FIG. 7, a record 302 may include a tax jurisdiction identifier 220A, a tax jurisdiction name or location 322, current effective dates 304, prior effective dates 306, current tax rates 308, prior tax rates 310, tax type 312, and administration code 220B. The administrative code may be included to facilitate determining tax jurisdiction information and may also identify whether a taxing jurisdiction is locally administered. Additional information may be associated for particular tax jurisdictions. For example, a state record may also include a county and local tax flag 314 and maximum tax information 316; a county record may include a county code 220A, a tax reporting code 318, and an exemption processing code 320; and a city record may include a city code 220A or a ZIP code, a location code 322 indicating the geographic location of the jurisdiction, a county code 220A, a county tax flag 314, a tax reporting code 318, and an exemption processing code 320. Entries in this database are made and updated by the transaction tax processor from time to time and/or as tax rates/amounts/calculation rules change using methods known in the art.

The standard and commodity tax rates are maintained in the tax rate, entity/use, and/or product/service databases and may be obtained directly from the Department of Revenue (“D.O.R.”). The tax rate data may be created and/or updated from time to time as tax rates are changed by federal, state and local governments. The tax rate data may also be obtained from federal, state, and local governments.

FIG. 5C illustrates an example table 380 for an address database, which includes one or more records 382. In general, each record associates a mailing address information with a tax jurisdiction identifier 220A. In this example, each record 382 includes mailing address information 384 which may include a street name 386, a street address number 388 which may be indicated as a range with a low number 390 and a high number 392, the side of the street 394, city name 396, state code 400, and zip code 402. The mailing address information may be associated with one or more tax jurisdiction identifiers 220A, including but not limited to, international, federal, state, county, city, fire district, police district, transit district, and school district. The tax jurisdiction identifier may be a textual description of the jurisdiction or may be any unique identifier including a numerical format to identify, state, county, municipality, and/or district. The address database may also include an effective date 404 for the taxing jurisdiction code. Entries in this database are made and updated by the transaction tax processor from time to time and/or as jurisdictions change using methods known in the art.

Each database may be any kind of database, including a relational database, object-oriented database, unstructured database or other database. Example relational databases include Oracle 8i from Oracle Corporation of Redwood City, Calif.; Informix Dynamic Server from Informix Software, Inc. of Menlo Park, Calif.; DB2 from International Business Machines of Yorktown Heights, N.Y., and Access from Microsoft Corporation of Redmond, Wash. An example object-oriented database is ObjectStore from Object Design of Burlington, Mass. An example unstructured database is Notes from the Lotus Corporation of Cambridge, Mass. A database also may be constructed using a flat file system, for example by using files with character-delimited fields, such as in early versions of dBASE, now known as visual dBASE from Inprise Corporation of Scotts Valley, Calif., formerly Borland International Corporation. Notwithstanding these possible implementations of the foregoing databases, the term database as used herein refers to any data that is collected and stored in any manner accessible by a computer.

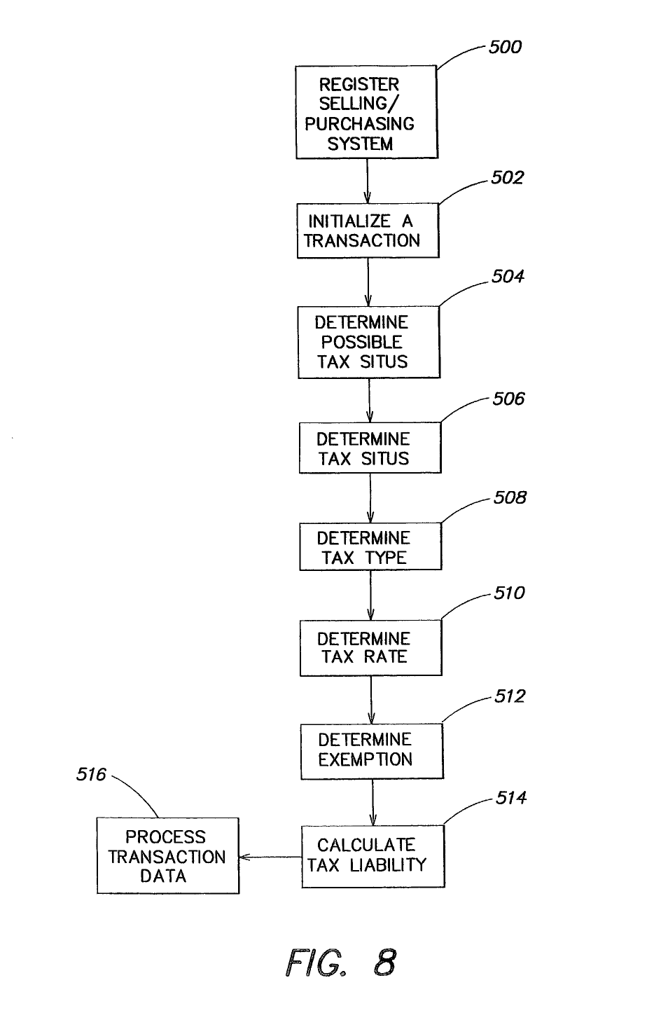

Having now described the databases maintained by the transaction processor in this embodiment, the various operations performed by the transaction processor will now be described. Referring to FIG. 8, these operations include, but are not limited to, registering (500) a selling/purchasing system by receiving information from a selling/purchasing system about the seller/purchaser; initializing (502) a transaction by receiving information from a selling/purchasing system about the seller, the purchaser, and/or the transaction; determining (504) the possible tax situs locations for the address data given; determining (506) the tax situs of the transaction; determining (508) the tax type of the transaction in the tax situs; determining (510) the standard tax rates of the transaction type in the tax situs; determining (512) the whole or partial tax liability exemption; calculating (514) the applicable tax liability to the transaction; and processing (516) transaction and tax liability data. The various operations in FIG. 8 need not be performed sequentially or in the order shown. These various operations will now be described in more detail.

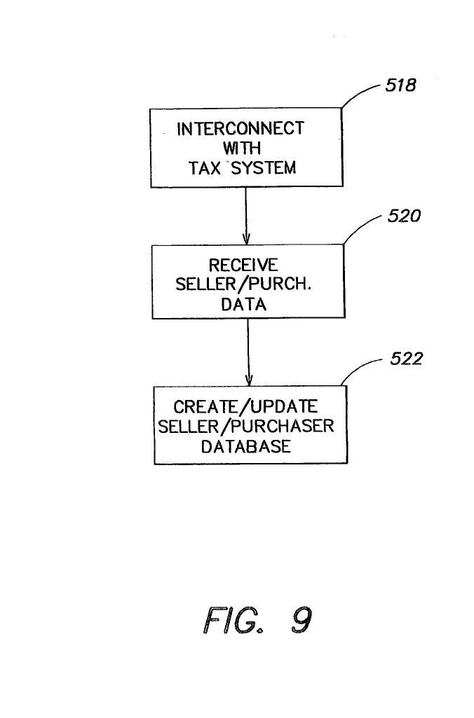

Referring to FIG. 9, to register a user such as a seller and/or purchaser, a selling/purchasing system interconnects (518) with the transaction tax compliance system. Information about the seller/purchaser is received (520) from the selling/purchasing system by the transaction tax processor. Information about the seller/purchaser, in an embodiment using the database structure described above, may include a seller/purchaser identifier, seller/purchaser name, seller/purchaser exemption number, seller/purchaser mailing address, seller/purchaser billing address, seller/purchaser phone number, commodity code, tax jurisdiction identifier, administration code, seller/purchaser location, seller/purchaser location activity code, address data, commodity category, commodity description, seller/purchaser division identifier, seller/purchaser entity identifier, and rounding indicator. Any conventional registration process and mechanism may be used to obtain this information from a selling/purchasing system. The seller/purchaser information may be provided separately and at different times, enabling the selling/purchasing system to register once, or to register or update data individually for each individual transaction or group of transactions.

Records in a seller database of FIG. 3A and/or purchaser database of FIG. 4B are created or updated (522) using the received information. In particular, the tax transaction processor associates a seller/purchaser identifier with the seller/purchaser information. A record for the seller is created or updated in the seller database and/or a record for the purchaser is created or updated in the purchaser database.

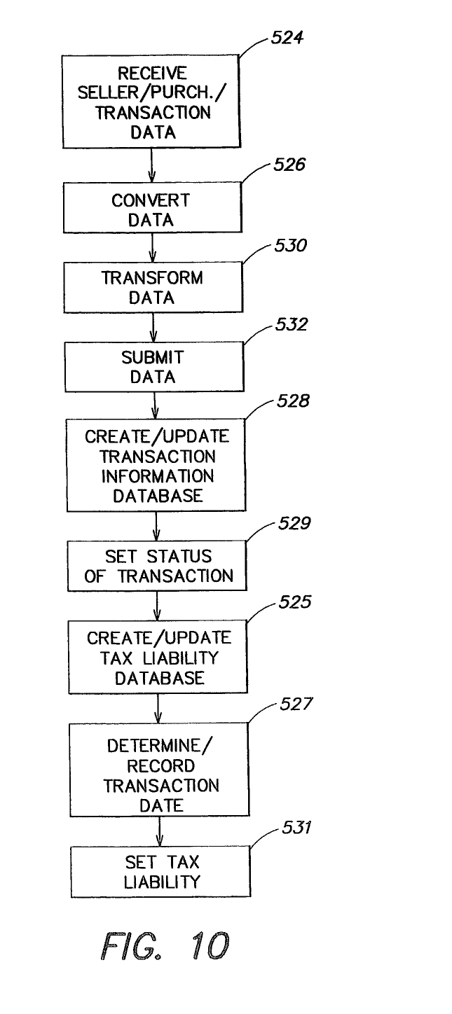

Referring to FIG. 10, after registering a selling/purchasing system, a particular transaction or group of transactions may be initialized 502 by the transaction tax processor after receiving information about the seller, the purchaser, and/or the transaction information (524) from the selling/purchasing system. Information about the seller, received from the seller, may be preregistered with the transaction tax compliance system or may be created or updated in real-time at the time of the transaction and further, using real-time processing. Similarly, the purchaser information may be preregistered with the transaction tax processor similar to the registration of the seller information or may be created or updated in real-time at the time of the transaction and may use real-time processing. The purchaser information may be received by the transaction tax processor directly from the purchaser system and/or through the seller system. Information about the seller, the purchaser, and the transaction, in an embodiment using the database structures described above, may include any transaction data including the sales or purchase price of the commodity sold or purchased (either by line item or invoice total), amount type flag, the amount of tax charged, the physical locations involved in the transaction (the ship from location, the ship to location, the location where the purchaser's invoice is mailed, the location where the order was first recorded, the location where the order was contractually accepted by the seller, and the location of title transfer), commodity code, reason code, seller/purchaser exemption identifier, jurisdiction identifier, contract amount, installation amount, freight amount, discount amount, credit indicator, number of items, rounding indicator, tax type identifier, no tax indicator in a particular jurisdiction, over-ride amount in a jurisdiction, invoice data, invoice number, invoice line item number, delivery date, seller/purchaser company code, seller/purchaser name, seller/purchaser division code, seller/purchaser identifier, tax jurisdiction, purchaser address data and completion code of the transaction. Any conventional registration process and mechanism may be used to obtain this information from a selling/purchasing system and the transaction tax compliance system.

The seller information, the purchaser information, and the transaction information may be provided separately and at different times, enabling the seller to register once but offer multiple items for sale through multiple transactions, and enabling the purchaser to register once and able to purchase multiple items through multiple transactions. The seller information, the purchaser information, and/or the transaction information may be provided to the transaction tax processor automatically by the selling/purchasing system or manually initialized or input by the seller/purchaser.

In one embodiment of the invention, the registration process for the seller, the purchaser, and the transaction is a web based graphical user interface or web-enabled application to provide a user interface to the selling/purchasing system. The selling/purchasing system then converts the input data to an extensible markup language (“XML”) format. The XML input data then may be transferred via hyper text transfer protocol (“HTTP”) to a JAVA web server of the transaction tax system (526). A JAVA web server may transform (530) the XML data into any applicable format usable by the transaction tax processor, which may include a string. The string is submitted (532) to the transaction tax processor via remote method invocation (“RMI”).

Additionally or alternatively, the selling/purchasing may also provide input and/or output file names during registration or initialization in which to submit the transaction data or in which to receive the tax liability data. The selling/purchasing system may contain programs compatible to the transaction tax system to enable interface or data readiness for the transaction tax system.

The selling/purchasing system may read the data from the input file and convert that data into XML format. The XML data is then transmitted to and received by (526) the JAVA web server. The JAVA server then transforms (530) the XML data into a format usable by the transaction tax processor which may include a string. The string is submitted (532) to the transaction tax processor via RMI.

Alternatively, the selling/purchasing system may use a web-enabled application to create a record in an applicable format including, but not limited to, XML format, with appropriate transaction information. The XML data may then be sent to and received by the JAVA server of the transaction tax system via HTTP web transmission. The JAVA server may then transfer (530) the XML data into a format usable by the transaction tax processor which may include a string. The string is submitted (532) to the transaction tax processor via RMI.

Records in the transaction information database of FIG. 4A are created or updated (528) using the received information. In particular, the transaction tax processor associates a seller identifier with the seller information, a purchaser identifier with the purchaser information, and a transaction identifier with the transaction information. A record for the transaction is created in a tax liability database, linked by the transaction identifier 237 and/or job number 374. The status of the transaction (529) for the transaction such as a completion code is set to an initialized value.

A table 291 (FIG. 6) for the transaction is then created (525), which is associated to the transaction information database through the transaction identifier (237 in FIG. 6) and/or job number 374. The transaction date 294 are determined and recorded (527) by the tax transaction processor or may be indicated by the selling/purchasing system. The selling/purchasing system may provide the seller, purchaser, and the transaction data known and/or required to determine and the tax report liability. The calculated tax liability is set (531) by the tax transaction processor as an initial amount of zero.

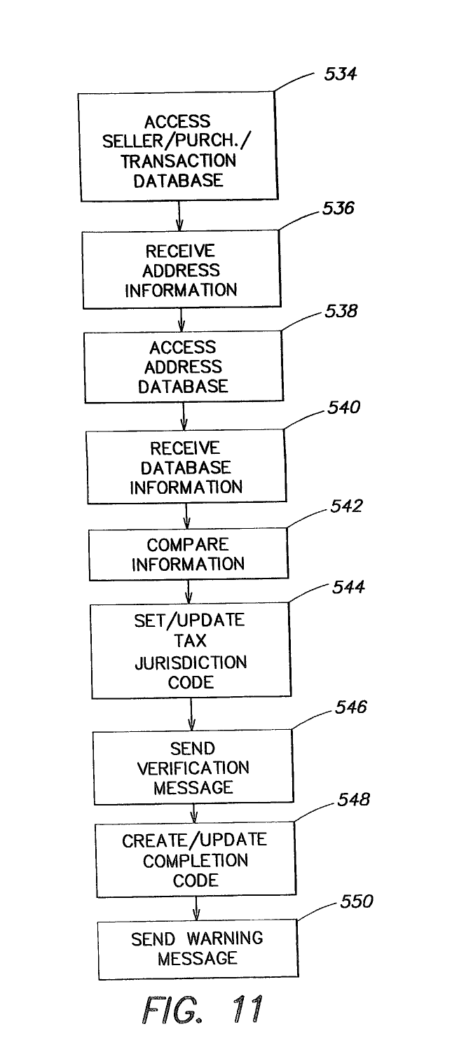

Referring to FIG. 11, after initializing the transaction, the address information provided in the seller address, the seller billing address, the seller location, the purchaser address, the purchaser billing address, the purchaser location, point of order origin, point of order acceptance, ship from location, ship to address, point of order origin, point of order acceptance, ship from location, ship to address, and/or point of title passage, may be used to determine the possible tax jurisdictions or nexus for the entities and/or the transaction. Possible tax jurisdiction maybe determined in many ways. For example, determining possible tax jurisdictions may involve accessing (534) the seller database, purchaser database, and/or transaction information database and receiving (536) address information related to the seller, purchaser, and/or transaction. An address database may be accessed (538) and address information and/or tax jurisdiction information may be received (540) from the address database.

At least one of the records in the address database is identified as matching the current address identifier, such as, the zip code, street address, city, county, state/province, and/or country. For example, the information about the address, such as the zip code, state, city, county, and/or street address in the transaction information database (FIG. 4A), may be compared (542) to the information in the address database. If the transaction address information is successfully matched with the received information, the taxing jurisdiction code (322, in FIGS. 4A and 6) is set or updated (544) to a value status, or identifier of a tax jurisdiction associated with a particular location. If the address information is successfully matched, the transaction tax processor may send (546) a verification message to the selling/purchasing system. Additionally or alternatively, the transaction tax processor may create or update (548) the completion code (236 in FIGS. 4A and 6) to indicate a successful result in the address manager. If the address information is not successfully matched, the transaction tax processor may send (550) a warning message or request for update message to the selling/purchasing system. Additionally or alternatively, the transaction tax processor may create or update (548) the completion code (236 in FIGS. 4A and 6) to indicate a problem in the address manager as possibly the reason for the problem.

The transaction tax processor may treat the lack of verification as merely a warning status or the lack of address association with a tax jurisdiction may cease further processing by the transaction tax processor until the tax location information is completely determined. The transaction tax processor may determine possible tax locations as the address information is first registered with the transaction tax processor, as in the case of seller and/or purchaser registration, or alternatively, the transaction tax processor may verify the address information in real-time during the time of the transaction and further, may use real-time processing. The tax transaction processor may from time-to-time verify the addresses in the seller and/or purchaser databases.

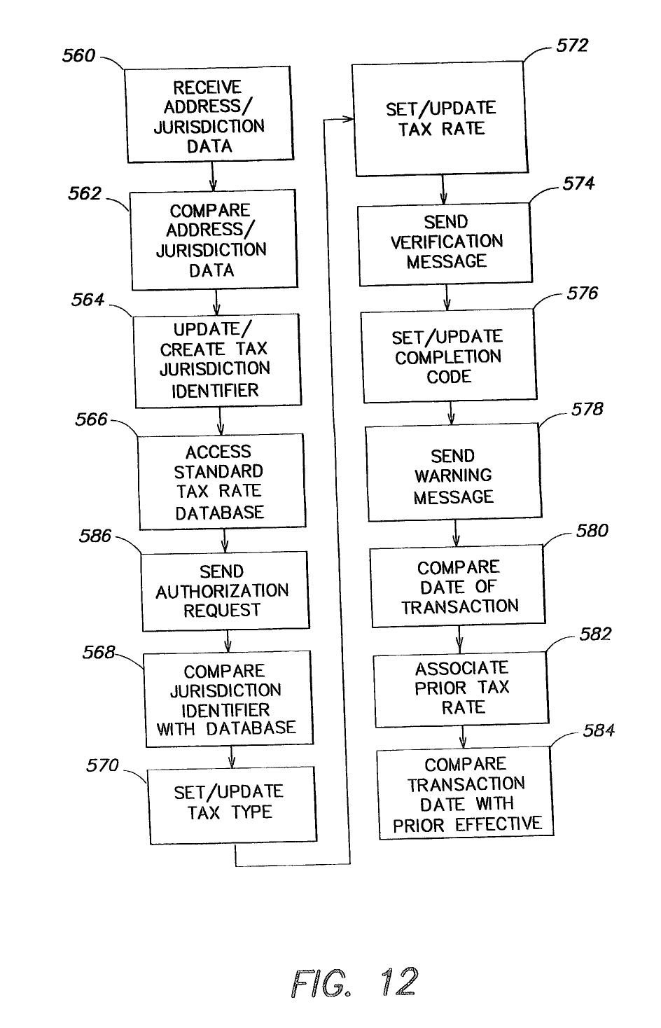

Referring to FIG. 12, after initializing the transaction, the tax situs, tax type, and tax rate may be determined for the transaction. To determine the tax situs 506 the taxing jurisdiction codes (322 in FIGS. 4A and 6) indicating the possible jurisdictions for addresses associated with the transaction may be received (560) from the transaction information database. In one embodiment, the transaction tax processor may receive the data string from the JAVA server via RMI. Alternatively, the tax rate manager may receive address information from the seller database and/or the purchaser database. Even further, the tax rate manager may also accept a tax situs specified by the selling/purchasing system from the seller database and/or the transaction information database. Nexus data in administration codes (244 in FIGS. 4A) allows sellers/purchasers to implement their tax collection obligations by turning off tax jurisdictions in which they have no physical presence, or alternatively, turning on taxing jurisdictions in which they have a physical presence; this data may be determined through seller/purchaser registration or may be determined from the address data in the seller, purchaser, and/or transaction databases. The nexus data may be input at the time of selling/purchasing system registration, at transaction initiation, or after prompting by the transaction tax processor. Any conventional registration or input process or mechanism may be used to obtain this information from the selling/purchasing system.

The applicable tax jurisdiction to the transaction may then be determined by comparing (562) the taxing jurisdiction codes, the address information, and/or a specified tax situs according to a rule database that associates a particular address and address type with the taxability situs. After determining the tax jurisdiction, the transaction tax processor may update (564) the tax jurisdiction identifier (220A, in FIGS. 4A and 6). In particular, the transaction tax processor associates a transaction identifier with the tax jurisdiction information. A record for the transaction is created or updated in the transaction database and the tax liability database. The tax jurisdiction identifier may be any identifier capable of identifying the applicable tax and jurisdiction, including, the zip code, geographic information system (“GIS”) data, NPA-NXX indicating telephone area code and the first three digits of a phone number, a stale code, or any identifier capable of identifying the taxable jurisdiction.

After the tax jurisdiction is determined, the tax type may be determined 508 and tax rate may be determined 510 in many ways, including accessing (566) standard tax rate database which associates a jurisdiction identifier with tax rate and applicable tax type. The tax rate manager may send (586) an authorization request to the selling/purchasing system requesting authorization to determine the tax situs, tax type, and/or applicable tax rates. At least one of the records in the standard tax rate database is identified as matching the current jurisdiction identifier. For example, the jurisdiction identifier for the transaction in the transaction information database (FIG. 4A) may be compared (568) to the information in the tax rate database. If the jurisdiction information is successfully matched with the received information, the tax type applicable to the transaction (312 in FIGS. 4A and 6) is set or updated to the applicable tax type (570) and the tax rate (370) in FIG. 6) is set or updated to applicable tax rate value (572). If the address information is successfully matched, the transaction tax processor may send (574) a verification message to the selling/purchasing system. Alternatively or additionally, the transaction tax processor may set or update (576) a completion code (236 in FIGS. 4A and 6) to indicate a successful determination of tax situs, tax type, and or tax rate. If the jurisdiction information is not successfully matched, the transaction tax processor may send (578) a warning message or request for update methods to the selling/purchasing system. Additionally or alternatively, the transaction tax processor may set or update (576) a completion code to indicate an encountered problem and/or a reason for an unsuccessful match. The transaction tax processor may treat the lack of verification as merely a warning status or may cease further processing of the transaction until the tax situs, tax type, and/or standard tax rate is successfully determined.

In addition, the tax rate manager may compare (580) the date of the transaction (296 in FIGS. 4A and 6) with a current effective date (304 in FIG. 7) of the tax type and tax rate indicated in the standard tax rate database. If the transaction date is within the data range of the current effective rate, the tax rate manager may associate (572) the current tax rate with the transaction. If the transaction date is earlier than the current effective date, the tax rate manager may then associate (582) a prior tax rate (310 in FIG. 7) with the applied tax rate for the transaction. Additionally, the date of the transaction may also be compared (584) to the prior effective date (306 in FIG. 7) of the prior tax rate to ensure that the correct tax rate is associated with the applied tax rate to the transaction.

The tax situs, tax type, and/or applicable tax rates may be determined in real-time and further, may be determined using real-time processing.

Referring to FIG. 13, after initializing the transaction, the exemption status of the purchaser may be set and verified for the transaction 512. Exempt products and services may be implemented by associating 600 an inventory code with a transaction tax system commodity code during the seller/purchaser registration process which may be through a web-based graphical user interface using a point and click process shown in FIG. 3E. The commodity code (218 in FIGS. 3A and 4A) may be associated in the product/service database with a particular exempt status in certain taxing jurisdictions or may be associated with a tax rate of zero in either the product/service database or the standard tax rate database. Usage and entity based exemptions may be implemented by associating (602) a purchaser and/or seller identifier with an exemption reason (233 in FIGS. 4A and 6) through the transaction tax processor.

Usage and entity based exemptions may be determined as the entity/use exemption is first registered with the transaction processor, as in the case of seller/purchaser registration, or alternatively, may be determined in real-time, and further, using real-time processing. The transaction tax processor may from time to time determine and/or verify the exemption of a specified product/service/entity/use.

The exemption status and amount may be determined in many ways. For example, the transaction tax compliance system may receive seller, purchaser, and transaction data (604) from the seller, purchaser, and transaction databases. More specifically, the exemption manager may receive the commodity code and/or reason code associated with the transaction from the transaction database. The transaction tax processor may then access (606) the product/service database and compare (608) the commodity code with the product/service database to determine whether that commodity code is associated with the wholly or partially exempt status. Similarly, the transaction tax processor may access (610) the entity/use database and compare (612) the reason code in the transaction data to data in the entity/use database to determine whether the user of the transaction tax compliance system has assigned a wholly or partially exempt status to the use of a product or a party involved in the transaction. If the commodity code and/or reason code is successfully matched with the received information, the exemption indicator (244 in FIG. 614) is set or updated to a status or value indicating the existence and/or type of an exemption. Furthermore, the transaction tax processor may set or update (616) the completion code (236 in FIG. 6) to a status or value indicating the existence of an exemption in the processing of the tax liability for the transaction. If the exemption information is not successfully matched, the transaction tax processor may send (618) a warning message, send a request of an update message to the selling/purchasing system, or set or update (616) a completion code indicating any problems encountered in determining the exemption status of a transaction.

The transaction tax processor may treat the lack of determination of exemption status or verification of exemption status as merely a warning status or may cease for the processing until the exemption information is completely determined and/or verified. The exemption manager may also accept (604) a specified tax exemption status directly from the selling/purchasing system including receiving exempt transaction amounts (320 in FIG. 4A) for a particular jurisdiction or tax type or, the selling/purchasing system may indicate that the complete transaction or part of the transaction may be exempt from taxation with a no tax indicator (354 in FIG. 4A) or with administration codes (244 in FIG. 4A) which indicate active and/or inactive tax jurisdictions and/or tax types for the entity and/or transaction. The exempt tax amount or tax rate may then be determined by accessing any one of the product/service database entity/use database and/or standard tax rate database.

More specifically, in one embodiment, the tax exemption manager compares the commodity code and state of the tax jurisdiction with the, product database. If there is a match, the exemption manager then accesses the state record. It then checks the state flag to determine the location of the rate in the state commodity code record, or whether to use the standard rate file or wholly exempt the transaction. The exemption manager then checks the city flag in the state record and then may access the product database with the city code for a particular tax jurisdiction and determine the location of the rate in the product database or standard rate database. The exemption manager may then check a county flag in a city record and access the product database with a county code for a particular tax jurisdiction and determine the location of the rate in the product database, standard rate database, or default value. The exemption manager may then check the maximum tax codes to determine how numeric fields may be used to calculate the maximum taxes (most tax laws for maximum tax liability amounts are based on a per line item or invoice amount). The exemption manager may then return a completion code indicating the success of tax calculation, any errors stopping tax calculation, or any errors overcome with default or determined values.

In a further embodiment of the invention, the transaction tax processor may access (620) information from an exemption data warehouse to verify the exemption status of the transaction by comparing exemption information with data from the exemption warehouse. At least one of the records in the purchaser, seller, product, and/or use database is identified as matching the current verification identifier, such as a commodity code, reason code, or an exemption certificate number. For example, the exemption information about the purchaser, seller, commodity, or use in the transaction information database may be compared (622) to the information from the exemption data warehouse. If the exemption information is successfully matched with the received information, the verification status 260 in FIGS. 4A and 6 is set or updated to a verified status or value (624). If the exemption information is successfully matched, the transaction tax processor may send (626) a verification message to the selling/purchasing system. Alternatively or additionally, the transaction tax processor may create or update (628) the completion code (236 in FIGS. 4A and 6) to indicate a successful or unsuccessful verification of exemption status. If the exemption information is not successfully matched, the tax transaction processor may send (630) a warning message or request for update message to the selling/purchasing, system.

The transaction tax processor may treat the lack of verification as merely a warning status, may cease further processing by the transaction tax processor until the exemption information is completely verified, or a non-exempt tax amount may be calculated by the transaction tax processor. The transaction tax processor may verify exemption information as the exemption information is first registered with the transaction tax processor, as in the case of seller and/or purchaser registration, or alternatively, the transaction tax processor may verify the exemption information in real-time during the time of the transaction and further, may use real-time processing. Alternatively, the transaction tax processor may verify the exemption information after the transaction is completed and may then send a warning message or update request to the selling/purchasing system. The tax transaction processor may from time-to-time verify the exemption data in the product/service and entity/use databases.

Referring to FIG. 14, after initializing the transaction, the appropriate tax amount may be calculated for the transaction 514. The transaction tax compliance system may determine the tax liability only if the transaction information is sufficient and/or verified. The transaction tax processor may cease to process the transaction, send a warning message or request for update to the selling/purchasing system, retrieve default transaction information, and/or update completion codes to indicate the transaction status and or difficulty.

Tax liability may be calculated in many ways. For example, calculating tax liability may involve receiving (632) seller, purchaser, and transaction data from the seller, purchaser, and transaction databases, more specifically, accessing and receiving data from the tax rate manager, exemption manager, seller database, purchaser database, and transaction database.

Calculating tax amount may also involve determining (634) if the no-tax indicator is associated with the transaction. If the no-tax indicator is flagged such that the selling/purchasing system specifies that no tax should be calculated for that part of the transaction, the transaction tax processor may create or update (636) the completion code (236 in FIGS. 4A-6) to indicate a no-tax indicator of tax liability processing.

The transaction tax processor may then determine if the selling/purchasing system has provided an administration code 244 that “turns off” taxation of a particular type in a particular jurisdiction. The transaction tax processor, to analyze the administration code, may compare (638) the administration code in the transaction information database with the jurisdiction identifier 220A and/or the tax type indicated 312 for a particular jurisdiction. If the match is successful, the transaction tax processor may cease processing of the transaction, send (640) a warning message or update request to the selling/purchasing system, and/or update (636) the completion code.

Similarly, the transaction tax processor may determine (642) if there is a selling/purchasing system provided override amount, e.g., a given tax amount to be applied to the transaction, or an override rate, e.g., a given tax rate to be applied to the transaction. The transaction tax processor may then use the specified tax amount or rate in calculating the tax liability by setting and updating (644) the applicable tax rate (370 in FIG. 6). Additionally, the transaction tax processor may send (640) a warning message to the selling/purchasing system and/or update (636) the completion code.

The transaction tax processor may then determine (646) any exemptions based on the entity status as determined by the exemption manager. The transaction tax processor may then determine (647) if there are any exemption indicators based on commodity or reason codes as determined by the exemption manager.

The transaction tax processor then receives (648) tax rate data from the tax rate manager, exemption manager, tax rate database, and/or exemption database maintained by the transaction tax processor and/or any third party system. The tax rate data is associated with a particular tax jurisdiction and is set by the laws and regulations of the tax jurisdiction and tax authority.

The tax rate may be a function of the transaction amount, the product or service, the tax type as determined by the tax jurisdiction, and/or any other factor relevant to tax rates. The appropriate tax rate may be different for different portions of the transaction based on the amount of the purchase or the products in the transaction. The transaction tax processor may exempt certain portions of transactions or certain transactions based on many types of exemptions indicated in the transaction database, standard tax rate database, product/service database and/or entity/use database, which may include product-based, purchaser or seller entity-based, and usage based exemptions.

Thus, the tax rate received from a tax rate database may be zero for a particular portion of a transaction or may be set to zero based on exemptions as determined by the transaction tax processor.

Calculating tax liability then involves calculating (650) the individual taxes in all applicable jurisdictions as indicated by the tax situs determined in the address manager and/or the selling/processing system. The transaction tax processor may then add all the returned taxes to determine (652) a total tax liability amount (104) for the transaction. In addition, the tax transaction processor may also add or combine (654) all of the applied tax rates to determine a single applied tax rate 370 for the transaction.

Records in the transaction and tax liability databases of FIG. 4A and FIG. 6 are updated (658) using the determined tax situs, tax rate, and type, and tax liability data. In particular, the transaction tax processor associates a transaction identifier with the tax jurisdiction, tax rate, tax type, and tax liability data. The transaction and tax liability data is also transmitted (656) to an appropriate processor such as the transaction information manager, to forward to the selling/purchasing system.

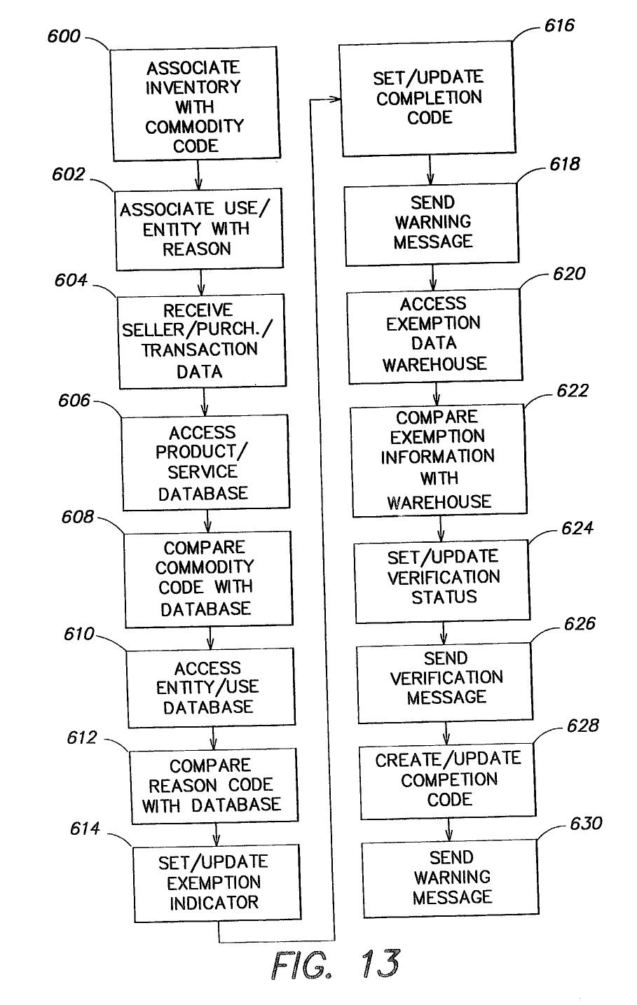

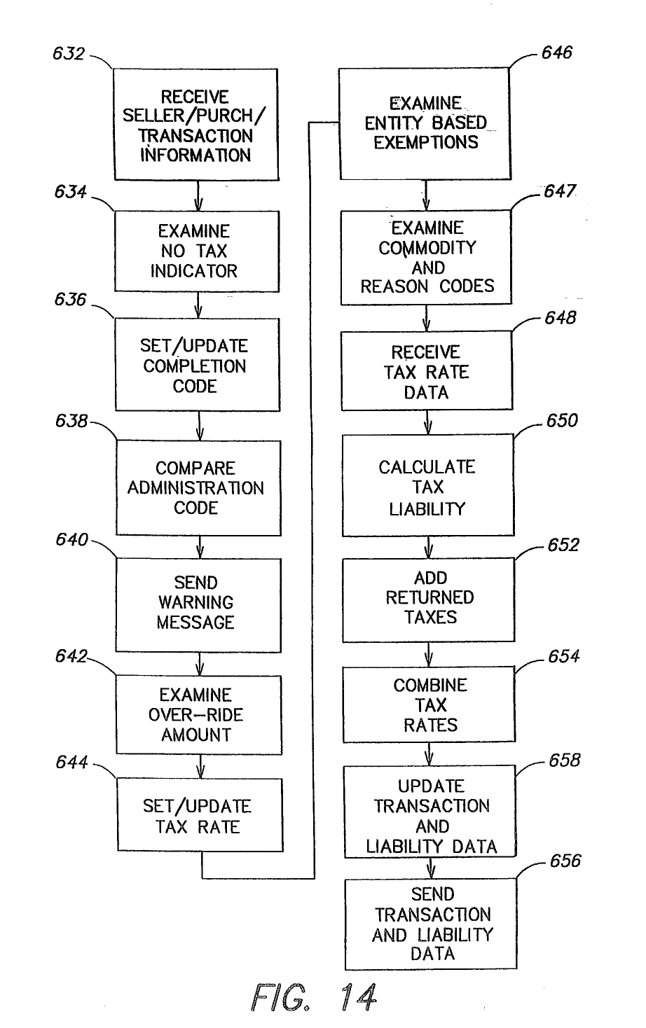

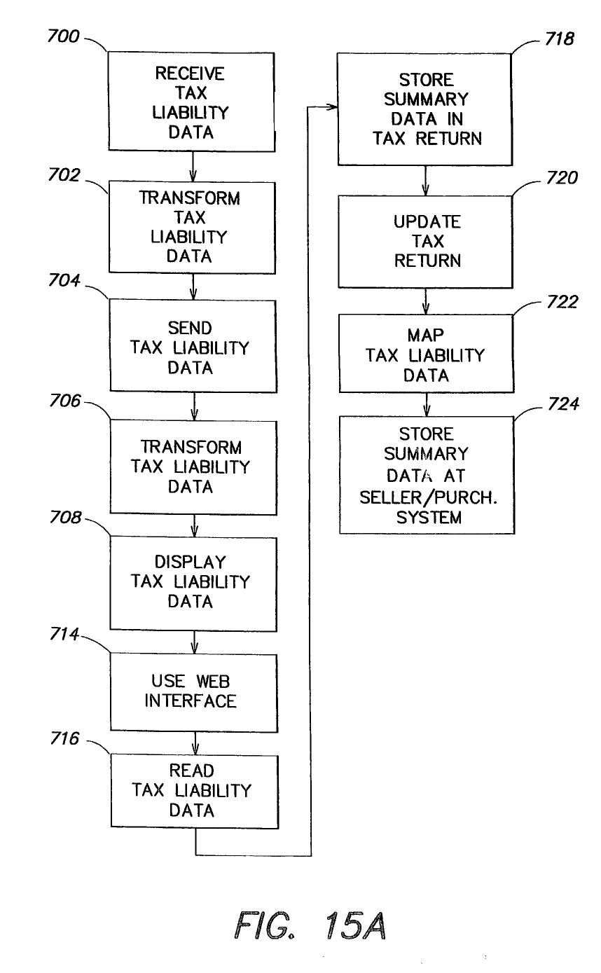

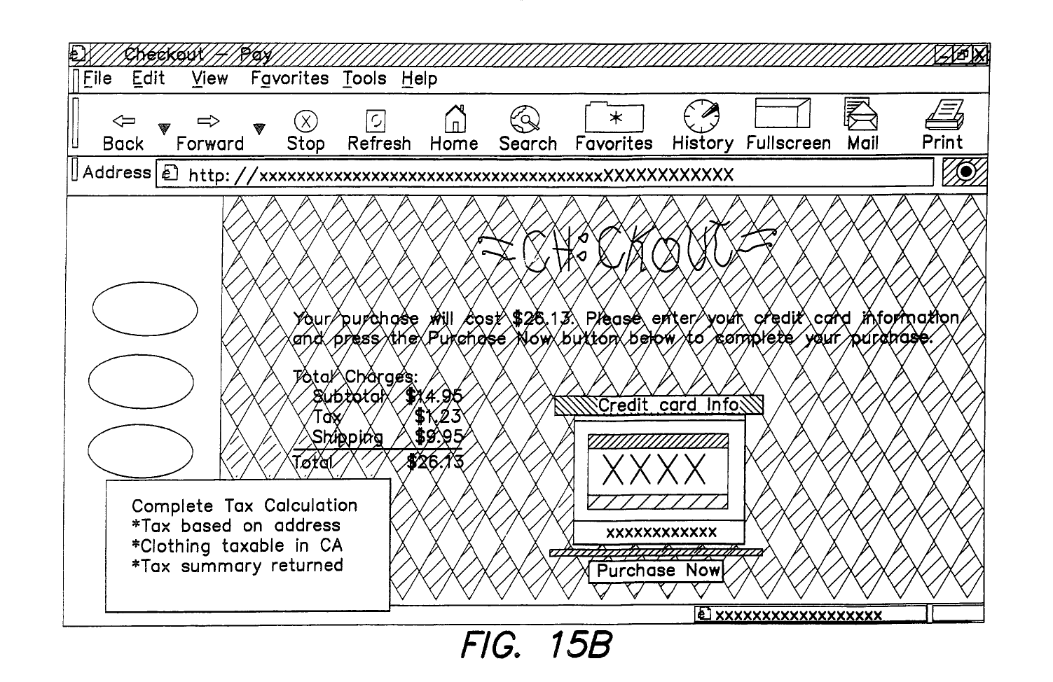

Referring now to FIG. 15A, after calculating the tax liability, the transaction tax processor processes the transaction and tax liability data to forward it to the selling/purchasing system. The tax liability information may be sent to the selling/purchasing billing system for entry onto the transaction document (e.g., the invoice) and/or stored in a tax liability information database of the transaction tax compliance system and/or the selling/purchasing system. The selling/purchasing system may forward the purchase/sale price and tax liability due to other transaction entities, or alternatively, the transaction tax system may send the data directly to the other entities, or made the data available for downloading or viewing to multiple parties. The transaction tax processor may automatically or manually (with selling/purchasing system authorization) send the tax liability information to the selling/purchasing system and/or other parties in real-time, or alternatively, the transaction tax processor may send the tax liability information after the transaction is completed either sequentially as transactions are processed, or in a batch mode.

The transaction information manager receives (700) the tax liability data from the tax calculator and may transform (702) the tax liability data into any data or signal receivable by another system, including the selling/purchasing system. The transaction tax processor may then send (704) the tax liability data to the applicable system.

In one embodiment, the JAVA server of the transaction tax processor receives (700) the output string via RMI from the tax calculator. The JAVA server may then transform (702) the output string received from the transaction tax processor into an XML format and the JAVA server then transmits (704) that XML data to the selling/purchasing system web page. The selling/purchasing system may then take the XML transaction data and transform (706) it into a readable text, which it displays (708) on the web page, an example of which is shown in FIG. 15B. The selling/purchasing system may also or alternatively take the XML data and display (708) it in its raw format for the user to browse. Alternatively, the selling/purchasing system may use a web-enabled application to interface (714) with the transaction tax processor. The XML data may then be transmitted (704) back to the web-enabled application via HTTP. The web-enabled application takes the XML data and reads (716) the results of the tax liability information.

The selling/purchasing system or the transaction tax processor may place or store (718) summary data from the tax liability information database file into the appropriate space on the seller/purchaser tax return. The system placing summary data in a tax return is preferably programmed in JAVA code and is Internet ready. JAVA code allows the system to be independent of the platform system, e.g., MS-DOS based systems, Apple-based systems, and/or IBM OS2 based systems. The transaction tax compliance system may include scanned tax forms and the calculation logic to determine the applicable tax to be reported and/or remitted. These tax forms may be related to sales and use taxes in addition to telecommunications, utilities, meal and beverage taxes, and any other tax schemes or types supported by the transaction tax compliance system. The appropriate tax forms and tax returns provided by the transaction tax compliance system may be provided to the transaction tax processor by taxing authorities to assure accuracy and compliance. The transaction tax processor may from time to time update (720) the forms and tax returns using methods known in the art.

The transaction and tax liability data may be mapped (722) to any format, allowing easy implementation into existing tax forms and/or tax authority processing systems. Such mapping may be done by the transaction tax processor or by the selling/purchasing system. When received by the selling/purchasing system, tax data from individual transactions may be summarized and added (724) to individual seller/purchaser records, reducing storage space.

In one embodiment of the invention, the transaction tax compliance system may be compensated for its operations and processes by many methods, including, but not limited to receiving from a tax authority or user (seller and/or purchaser) a fee based on the number of transactions processed, the transaction amount of the transaction processed, a percentage of the tax liability determined and/or exempted, or a set fee.

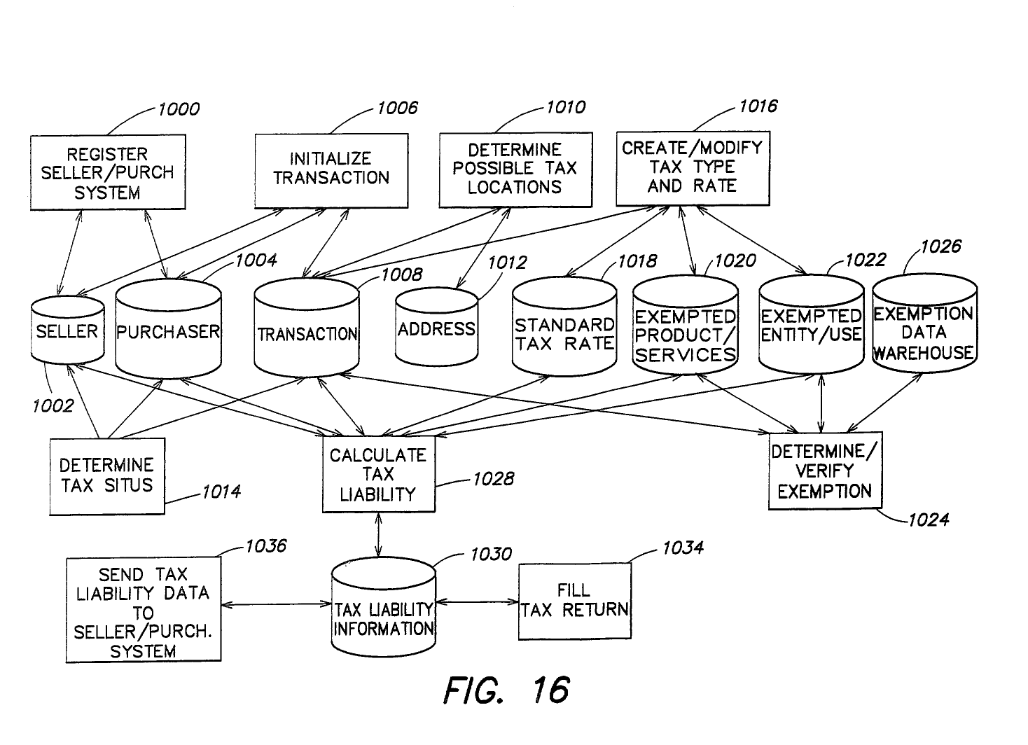

Referring now to FIG. 16, a block diagram of the activities described in FIGS. 8-15A and how they interact with the databases of FIGS. 3A-7 will now be described. As indicated at 1000, registration of the selling/purchasing system uses the seller database 1002 and/or the purchaser database 1004. Initialization of the transaction 1006 uses at least the transaction database 1008, the seller database 1002, and the purchaser database 1004. Determination of possible tax locations for the transactions entity or a transaction 1010 uses at least the transaction database 1008 and the address database 1012 to associate address data and the transaction information with a taxing jurisdiction identifier. Determination of the tax situs 1014 uses at least information from the transaction database 1008 and optionally from the seller database 1002 and/or the purchaser database 1004. Creation or modification of the tax rate and the tax type 1016 for a transaction uses at least standard tax rate database 1018 and the transaction database 1008, and optionally the exempted products/services database 1020 and/or the exempted entities/use database 1022. The exempted products/service database 1020 and entity/use database 1022 may also be used to determine and/or verify 1024 any exemptions to tax liability also using the transaction information database 1008 and optionally an exemption data warehouse 1026. The tax liability is calculated 1028 using the transaction information database 1008 and optionally the seller database 1002, the purchaser database 1004, the standard tax rate database 1018, the product/services database 1020, the entity/use database 1022, and the tax liability information database 1030. Transaction information may be sent 1-36 to the selling/purchasing system and/or processed to fill a tax return 1034 using the transaction information database 1008, the tax liability database 1032, and optionally the seller database 1002, the purchaser database 1004, and any databases holding information applicable to completing the tax return, including the standard tax rate database 1018, the product/service database 1020, and the entity/use database 1022.

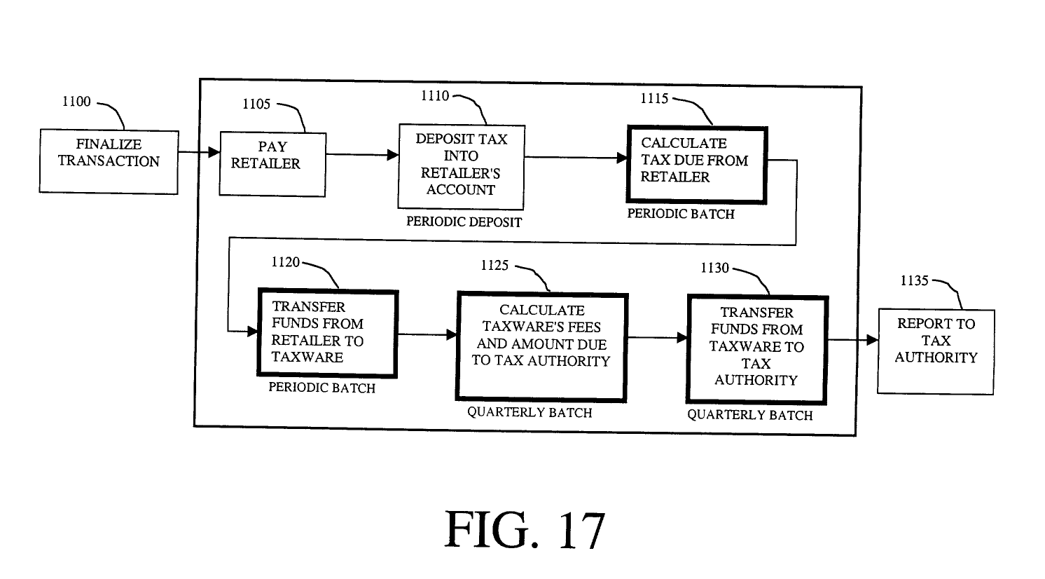

FIG. 17 is a flow chart of the general operation of the Tax System of the present invention showing the movement of money into and out of the system. A merchant will finalize the transaction, block 1100. The merchant collects the tax liability from the purchaser, box 1105, and deposits that tax into the merchant's account, 1110. Periodically, the taxes due to the tax authority are calculated by the present invention, block 1115. Funds are then transferred from the merchant to the depository account for the tax system, block 1120. The system then calculates the service fees for the tax system and the amount due to the tax authority, block 1125. The tax system then transfers funds from the system depository account to the tax authority, block 1130. A report to the tax authority is then generated and sent, block 1135. Although FIG. 17 shows a “quarterly batch” for taxing authority transfers, for states requiring more frequent remittances other periodic batches may apply, and the invention could perform this on a transaction-by-transaction basis in “real time” or near “real time”.

The financial flow subsystem of the Tax System produces messages to initiate funds transfers. The subsystem receives reports of float income. The subsystem produces reports that detail and reconcile the following account activity: the subsystem transfers money from Merchants' Accounts to the Tax System Holding Account; the subsystem transfers money from the Tax System Holding Account to the Tax System Depository Account and the 3rd Party Depository Account (if a third party contractor is utilized); and, the subsystem transfers money from the Tax System Holding Account to the Taxing Authority Accounts.

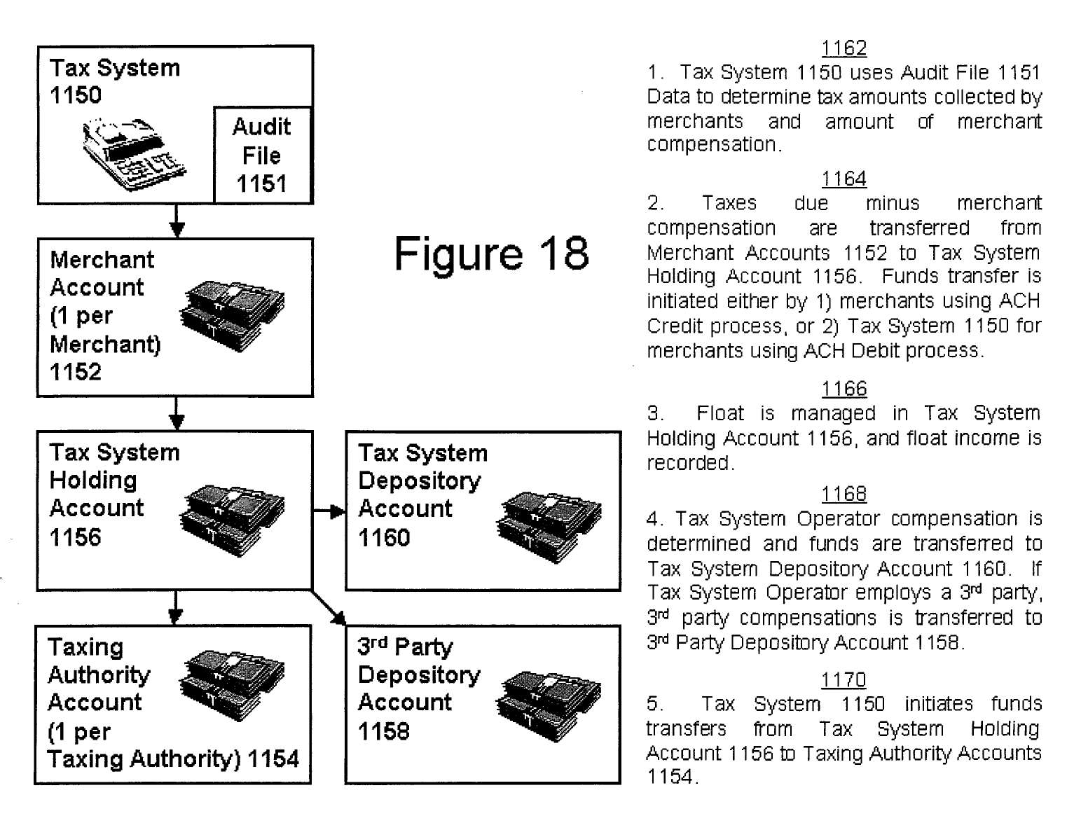

FIG. 18 is a flow chart of the money management and reconciliation module of the Tax System. The following accounts are used in this process: one Merchant Account for each participating merchant 1152; one Tax System Holding account 1156; one or more 3rd Party Depository Accounts for any third party contractors employed in the process 1158; one Tax System Depository Account for the Tax System 1160; and, one Taxing Authority Account for each participating taxing authority 1154. The Tax System establishes a means to set up criteria for each entity remitting taxes, and for each entity receiving tax or compensation income. To manage the financial flow for tax and compensation payment, tables are developed for the merchant, the taxing authority, and for the Tax System Operator (and any 3rd party contractors employed by the Tax System Operator).

There are five steps that are accomplished by this module:

Step 1 [1162]. The Tax System 1150 summarizes the transactional data in the Audit File 1151 to determine the amount of tax to be remitted to each applicable taxing authority and merchant compensation. Merchant compensation is based upon retention of any vendor discount authorized by a participating taxing authority (e.g., the state of Michigan allows merchants to retain 0.5% of taxes they collect from their customers), and/or a percentage of Tax System Operator compensation.

Step 2 [1164]. A table is established for the schedule for regular, periodic funds transfers between the Merchant Accounts 1152 and the Tax System Holding Account 1156. The timing of the transfer is adjusted to accommodate the lapsed time from the time the Tax System 1150 message is generated to the time the money is taken from the Merchant Account 1152. The amount of funds to be transferred consists of the tax due to be remitted to taxing authorities less any merchant compensation. The Tax System 1150 either 1) notifies the merchant of the date and the amount of each Automated Clearing House Credit transfer that the merchant must initiate, or 2) automatically debits the Merchant's Account 1152 (using Automated Clearing House Debit) if the merchant has previously granted the Tax System Operator permission to do so.

The amount of money to be transferred from the Merchant Accounts 152 to the Tax System Holding Account 1156 is calculated using the following steps:

a) The Tax System 1150 sums the total tax amount collected by each merchant. This is the base amount from which the merchant compensation is subtracted.

b) The Tax System 1150 performs compensation calculations.

First the Tax System 1150 sorts the transactions by taxing authority. The Tax System 1150 then performs a taxing authority-based vendor discount calculation if the taxing authority allows such discounts. The Tax System 1150 then multiplies the tax totals for the taxing authority by the allowable merchant discount percentage, and provides and reports one total for the discount amount.

c) The Tax System 1150 performs percentage of per transaction compensation calculation. The Tax System 1150 counts the number of finalized transactions for each merchant for each taxing authority. The Tax System 1150 then multiplies the number of finalized transactions by, for example, $0.03, to determine Tax System Holding Account 1156 potential. The Tax System 1150 then multiplies the derived total by the merchant contract compensation percentage share. Finally, the Tax System 1150 provides and reports total Merchant compensation based upon per transaction fee.

d) The Tax System 1150 calculates the percentage allowance for new taxes collected. The Tax System 1150 first sums new tax amounts by taxing authority. The Tax System 1150 then multiplies the new tax amount per taxing authority by the percentage compensation by taxing authority to determine Tax System Holding Account 1156 potential. The Tax System 1150 then multiplies the Tax System Holding Account 1156 compensation by taxing authority amount by the merchant contract compensation percentage share. Finally, the Tax System 1150 provides and reports merchant compensation by taxing authority amount.

e) The Tax System 1150 calculates the amount of Tax System Operator compensation to be forwarded to the merchant as merchant compensation, in the event that the Tax System Operator has awarded a merchant a percentage of the Tax System Operator's compensation. The Tax System 1150 multiplies the amount of Tax System Operator compensation by the merchant compensation percentage to determine the merchant compensation amount. The amount of merchant compensation is subtracted from the tax amount to be transferred from the Merchant Account 1152 to the Tax System Holding Account 1156.

Step 3 [1166]. Float is managed in the Tax System Holding Account 1156. Tax System Operator compensation is linked to float in the Tax System Holding Account 1156. Float is the amount of money made in interest during the time between collection of the tax from the merchant and remittance of that tax to the applicable taxing authority. These funds are invested through short-term third party financial instruments. The float income is variable and is determined by Account investment outcome.

The Tax System 1150 records the amount of tax collected from the merchant, and also records float income. Float income is reported at regular, periodic intervals and constitutes a portion of the compensation that is dispersed between the Tax System Operator and any 3^{rd} party contractors. If a 3rd party is managing the float income, the Tax System 1150 creates a message format to receive float income reports from that 3^{rd} party. The Tax System 1150 receives the float income message, and incorporates that message in the reporting and reconciliation reports to any 3^{rd} party contractors.

Step 4 [1168]. The Tax System 1150 determines the Tax System Operator compensation, based upon contractual agreement with Taxing Authorities. The Tax System 1150 then initiates a funds transfer from the Tax System Holding Account 1156 to the Tax System Depository Account 1160. A table is established for the schedule for regular, periodic Tax System Operator funds transfers between the Tax System Holding Account 1156 and the Tax System Depository Account 1160. The timing of the transfer is adjusted to accommodate the lapsed time from the time the Tax System 1150 message is generated to the time the money is taken from the Tax System Holding Account 1156.

In addition to float income, a Tax System Operator can be compensated through 1) a percentage of “new tax,” the taxes collected by merchants in taxing jurisdictions where they do not have an existing responsibility to do so, and/or 2) a fee for every transaction processed by the Tax System 1150. Tax System Operator compensation can be “capped” following contractually-agreed criteria. Tax System Operator compensation is determined as follows:

a) The Tax System 1150 determines whether a compensation cap applies by calculating the amount of the cap (e.g., if compensation is capped by the amount of new tax collected by the Tax System 1150, then Tax System 1150 will calculate the amount of total new tax collected to determine the cap).

b) The Tax System 1150 then calculates potential Tax System Operator compensation by counting all transactions processed for all taxing authorities. The compensation amount could be calculated at, for example, $0.03 per transaction. The Tax System 1150 provides and reports per transaction compensation potential.

c) The Tax System 1150 then sorts transactions by taxing authority. The Tax System 1150 sorts only transactions subject to new tax, and applies percentage compensation allowed by taxing authority for voluntary tax collected. The Tax System 1150 provides and reports percentage compensation potential.

d) The Tax System 1150 then sums the calculated compensation amount at, for example, $0.03 per transaction plus the percentage compensation allowed for new tax collected. The Tax System 1150 provides and reports the sum of calculated per transaction compensation plus calculated percentage compensation.

e) The Tax System 1150 then calculates the amount to be transferred as Tax System Operator compensation into the Tax System Depository Account 1160 by comparing the calculated Tax System Operator compensation total against the compensation cap, if such a cap exists. If, for example, the sum of the $0.03 compensation per transaction plus the percentage compensation allowed for new tax collected is greater than the cap (for example, the total amount of new tax collected), then subtract the compensation amount above the cap from the Tax System Operator compensation.

In the event that the Tax System Operator employs a 3rd party, Tax System Operator compensation is distributed in accordance with the contracted percentage distribution to each of the 3rd Party Depository Accounts 1158. For example, the Tax System Operator may agree to compensate a 3rd Party for managing float income, in exchange for 5% of the float income generated by the Tax System 1150.

Step 5 [1170]. The Tax System 1150 initiates funds transfers for the amount of money to be taken from the Tax System Holding Account 1156 and deposited into each Taxing Authority Account 1154, representing the remittance of taxes collected by the merchants to the applicable taxing authority. The Tax System 1150 determines the amount of funds to be transferred to Taxing Authority Accounts 1154 by 1) calculating and sorting total tax amounts according to the amount owed by merchant by taxing authority, 2) summing by merchant and providing a total, 3) summing all merchant amounts and providing totals by taxing authority, and 4) providing a total for all merchants by taxing authority. A table is established for the schedule for regular, periodic funds transfers between the Tax System Holding Account 1156 and the Taxing Authority Accounts 1154. The timing of the transfer is adjusted to accommodate the lapsed time from the time the Tax System 1150 message is generated to the time the money is taken from the Tax System Holding Account 1156. The amount of money transferred to the Taxing Authority Accounts 1154 equals the total tax collected from all merchants minus the Tax System Operator compensation.

The Tax System Operator will maintain a Tax System Holding Account 1156 “cushion.” The “cushion” is an amount of funds or credit that can be used when the funds received from a merchant are inadequate to satisfy that merchant's tax liability (i.e., due to a high merchant compensation amount). This “cushion” amount can be predetermined by the Tax System Operator's accounting office, or it may be a line of credit from the bank to cover negative balances.

The Tax System 1150 develops management reconciliation reports for all of the Financial Flow. Each time money moves from one account to another, a Master Report is created for the tax system management. This Master Financial Flow Report reconciles all funds movement. That is, each amount transferred is summarized and explained and footed to each account balance, taxes owed, compensation paid and taxes paid.

The following is an example of the application of the present invention:

Merchant A

Located in KS

Tax collection obligation in KS, WI, MI

Merchant Compensation:

Receives 0.5% vendor discount in MI

Receives 0.5% of new tax Merchant A collects

Receives 10% of the $0.03 per transaction fee for MI, KS, NC

Tax funds to be transferred from Merchant Account 1152 to Tax

System Holding Account 1156 every 7 days

Merchant B

Located in WI

Tax collection obligation in WI, KS

Merchant Compensation:

Receives 0.5% vendor discount in MI

Tax funds to be transferred from Merchant Account 1152 to Tax

System Holding Account 1156 every 14 days

Merchant C

Located in NC

Tax collection obligation in NC, KS, WI, MI

Merchant Compensation:

Receives 0.5% vendor discount in MI

Receives 10% of the $0.03 per transaction fee for MI, KS, NC

Merchant D

Located in NC

Tax collection obligation in NC

Merchant Compensation:

Receives 0.5% vendor discount in MI

Receives 0.5% of new tax Merchant D collects

Receives 5% of the $0.03 per transaction fee for MI, KS, NC

Tax funds to be transferred from Merchant Account 1152 to Tax

System Holding Account 1156 every 7 days

Assumptions:

Taxes are paid to taxing authority on the 25th day after the end of every quarter

Float income for Tax System Holding Account 1156 is reported monthly

Tax System Operator compensation is transferred to the Tax System

Depository Account 1160 quarterly

Tax System Operator is employing a 3rd party

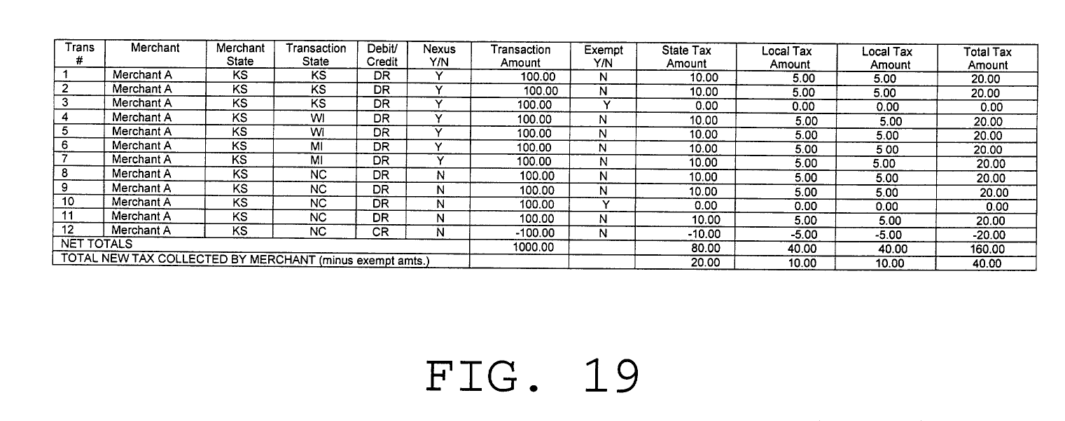

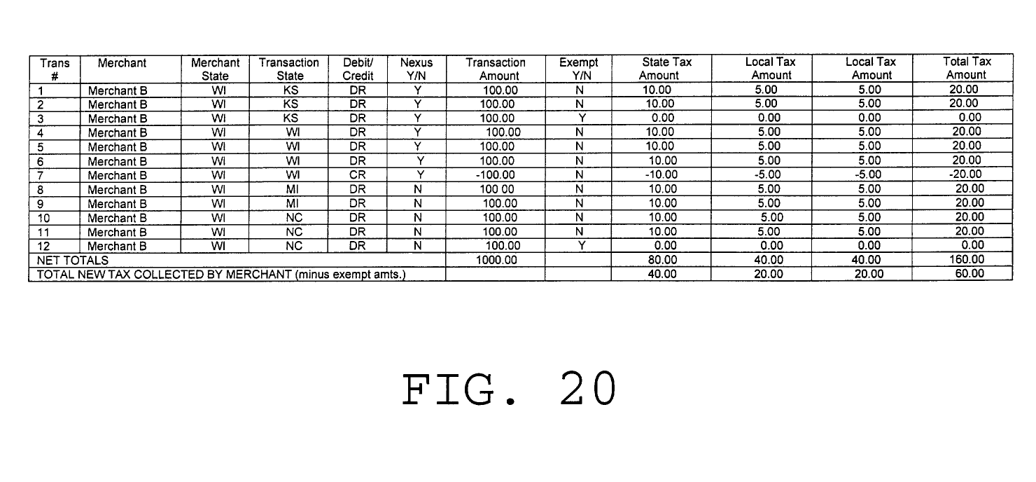

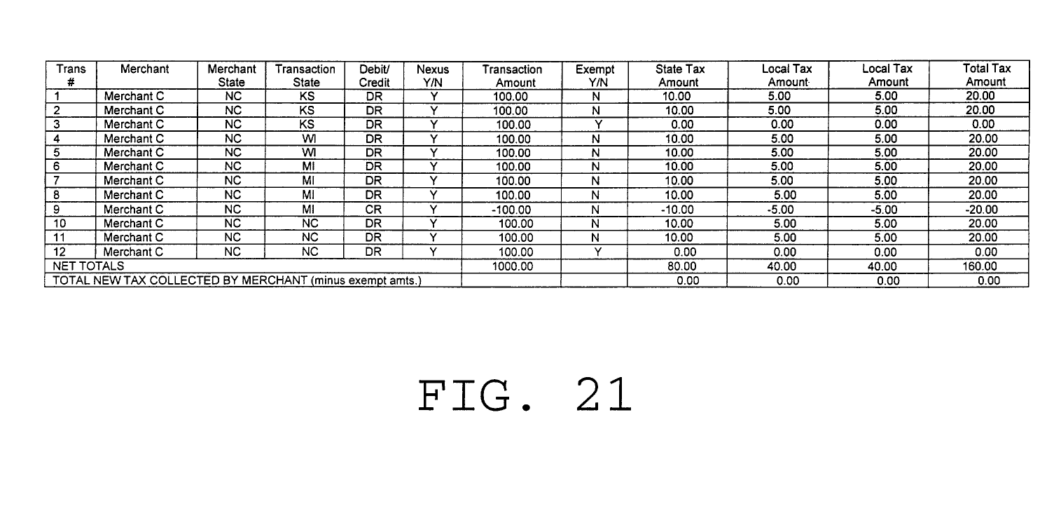

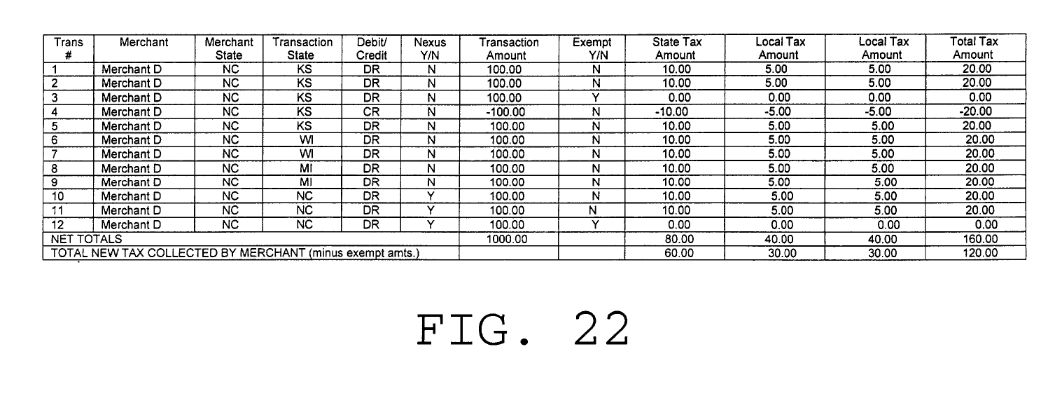

Financial Flow Sample Transactions are shown in the tables of FIGS. 19-22. The tax amounts are examples for illustrative purposes only. The transactions are sorted by Merchant and taxing authority. Total tax due by merchant is provided. Total new tax collected by merchant is provided. Each Merchant receives a report containing, at a minimum, the items displayed on the charts in the figures as well as the Merchant Reports as defined following the Sample Transactions.

Sample Reports to Merchants

Merchant A Report Content

| State of Kansas | |
|---|---|
| (Receives 0.5% of new tax Merchant A collects) | |
| New Tax Collected in KS = $ 0.00 | $ .00 |
| 0.5% of 00.00 = $ 0.00 | |
| (Receives 10% of the $ 0.03 per transaction fee) | |
| 3 transactions in KS × $ 0.03 = .09 | $ .01 |
| 10% of $ 0.09 = $ 0.01 (5/4 rounding) | |
| State of North Carolina | |
| (Receives 0.5% of new tax Merchant A collects) | |
| New Tax Collected in NC = 40.00 | $ .20 |
| 0.5% of 40.00 = $ 0.20 | |
| (Receives 10% of the $ 0.03 per transaction fee) | |
| 5 transactions in NC × $ 0.03 = $ .15 | $ .02 |
| 10% of $ 0.15 = $ .02 (5/4 rounding) | |
| State of Wisconsin | |
| (Receives 0.5% vendor discount in WI) | |
| Tax Collected in WI = $ 40.00 | $ .20 |
| 0.5% of $ 40.00 = $ 0.20 | |
| (Receives 0.5% of new tax Merchant A collects) | |
| New Tax Collected in WI = $ 0.00 | $ .00 |
| 0.5% of 0.00 = $ 0.00 | |
| State of Michigan | |
| (Receives 0.5% vendor discount in MI) | |
| Tax Collected in MI $ 40.00 | $ .20 |
| 0.5% of $ 40.00 = $ 0.20 | |
| (Receives 0.5% of new tax Merchant A collects) | |
| New Tax Collected in MI = $ 0.00 | $ .00 |
| 0.5% of 0.00 = $ 0.00 | |
| (Receives 10% of the $ 0.03 per transaction fee) | |
| 2 transactions in MI × $ 0.03 = $ 0.06 | $ .01 |
| 10% of $ 0.06 = .01 (5/4 rounding) | |
| Total Merchant Compensation | $ .64 |
| Total Tax due to four States | $ 160.00 |
| Total to be remitted by Merchant A | $ 159.36 |

Merchant B Report Content

| State of Kansas | |
|---|---|
| State of North Carolina | |
| State of Wisconsin | |
| (Receives 0.5% vendor discount in WI) | |
| Tax Collected in WI - $ 40.00 | $ .20 |
| 0.5% of $ 40.00 = $ 0.20 | |
| State of Michigan | |
| (Receives 0.5% vendor discount in MI) | |
| Tax Collected in MI = $ 40.00 | $ .20 |
| 0.5% of $ 40.00 = $ 0.20 | |
| Total Merchant Compensation | $ .40 |
| Total Tax due to four States | $ 160.00 |
| Total to be remitted by Merchant B | $ 159.60 |

Merchant C Report Content

| State of Kansas | |
|---|---|
| (Receives 10% of the $ 0.03 per transaction fee) | |
| 3 transactions in KS × $ 0.03 = .09 | $ .01 |
| 10% of $ 0.09 = $ 0.01 (5/4 rounding) | |
| State of North Carolina | |
| (Receives 10% of the $ 0.03 per transaction fee) | |
| 3 transactions in NC × $ 0.03 = $ .09 | $ .01 |
| 10% of $ 0.09 = $ 0.01 (5/4 rounding) | |
| State of Wisconsin | |
| (Receives 0.5% vendor discount in WI) | |
| Tax Collected in WI = $ 40.00 | $ .20 |
| 0.5% of $ 40.00 = $ 0.20 | |
| State of Michigan | |
| (Receives 0.5% vendor discount in MI) | |
| Tax Collected in MI = $ 40.00 | $ .20 |
| 0.5% of $ 40.00 = $ 0.20 | |
| (Receives 10% of the $ 0.03 per transaction fee) | |
| 4 transactions in MI × $ 0.03 = $ 0.12 | $ .01 |
| 10% of $ 0.12 = .01 (5/4 rounding) | |
| Total Merchant Compensation | $ .43 |
| Total Tax due to four States | $ 160.00 |
| Total to be remitted by Merchant C | $ 159.57 |

Merchant D Report Content

| State of Kansas | |
|---|---|
| (Receives 0.5% of new tax Merchant D collects) | |
| New Tax Collected in KS = 40.00 | $ .20 |
| 0.5% of 40.00 = $ 0.20 | |
| (Receives 5% of the $ 0.03 per transaction fee) | |
| 5 transactions in KS × $ 0.03 = .15 | $ .01 |
| 5% of $ 0.15 = $ 0.01 (5/4 rounding) | |
| State of North Carolina | |
| (Receives 0.5% of new tax Merchant D collects) | |
| New Tax Collected in NC = 0.00 | $ .00 |
| 0.5% of 0.00 = $ 0.00 | |
| (Receives 5% of the $ 0.03 per transaction fee) | |
| 3 transactions in NC × $ 0.03 = $ .09 | $ .00 |
| 5% of $ 0.09 = $ .00 (5/4 rounding) | |
| State of Wisconsin | |
| (Receives 0.5% vendor discount in WI) | |
| Tax Collected in WI = $ 40.00 | $ .20 |
| 0.5% of 40.00 = $ 0.20 | |
| (Receives 0.5% of new tax Merchant D collects) | |
| New Tax Collected in WI = $ 40.00 | $ .20 |
| 0.5% of 40.00 = $ 0.20 | |
| State of Michigan | |
| (Receives 0.5% vendor discount in MI) | |
| Tax Collected in MI = $ 40.00 | $ .20 |
| 0.5% of $ 40.00 = $ 0.20 | |
| (Receives 0.5% of new tax Merchant D collects) | |
| New Tax Collected in MI = $ 40.00 | $ .20 |
| 0.5% of 0.00 = $ 0.20 | |
| (Receives 5% of the $ 0.03 per transaction fee) | |
| 2 transactions in WI × $ 0.03 = $ 0.06 | $ .00 |
| 5% of $ 0.06 = .00 (5/4 rounding) | |
| Total Merchant Compensation | $ 1.01 |
| Total Tax due to four States | $ 160.00 |
| Total to be remitted by Merchant D | $ 158.99 |

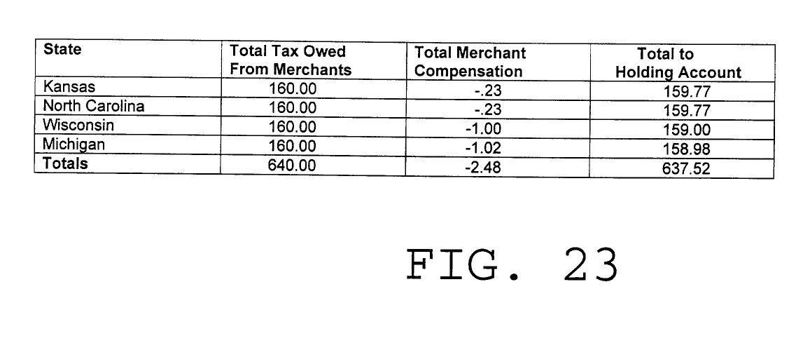

FIG. 23 is a table of money to be paid to taxing authorities following the examples above.

Money to be Paid to States

State of KS

Total Tax Collected for KS=160.00

New Tax Collected for KS=40.00

# of Transactions=14

($0.03 per transaction)

14 transactions in KS@0.03 per transaction $0.42

(6% of new tax collected)

40.00×0.06=2.40

Sum of compensation amounts=2.82

Sum of compensation is<Total new tax

Therefore Compensation=2.82

Tax owed to State=157.18

State of NC

Total Tax Collected for NC=160.00

New Tax Collected for NC=80.00

# of Transactions=14

($0.03 per transaction)

14 transactions in KS@0.03 per transaction $0.42

(6% of new tax collected)

80.00×0.06=4.80

Sum of compensation amounts=5.22

Sum of compensation is<Total new tax

Therefore Compensation=5.22

Tax owed to State=154.78

State of WI

Total Tax Collected for WI=160.00

New Tax Collected for WI=40.00

(5% of new tax collected)

30.00×0.05=1.50

Sum of compensation amounts=1.50

Sum of compensation is<Total new tax

Therefore Compensation=1.50

Tax owed to State=158.50

State of MI

Total Tax Collected for MI=160.00

New Tax Collected for MI=80.00

# of Transactions=10

($0.03 per transaction)

10 transactions in KS@0.03 per transaction $0.30

(6% of new tax collected)

80.00×0.06=4.80

Sum of compensation amounts=5.10

Sum of compensation is<Total new tax

Therefore Compensation=5.10

Tax owed to State=154.90

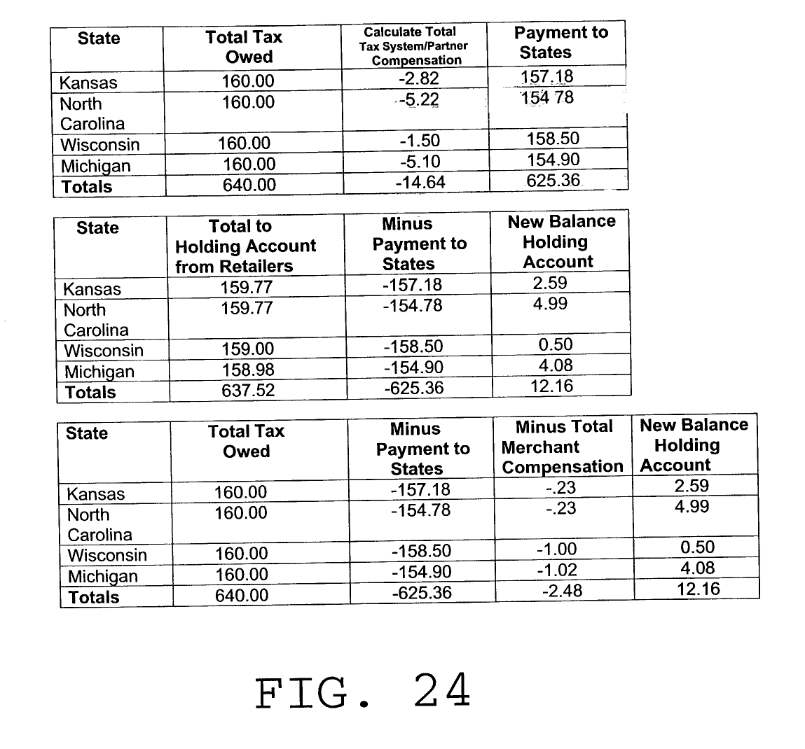

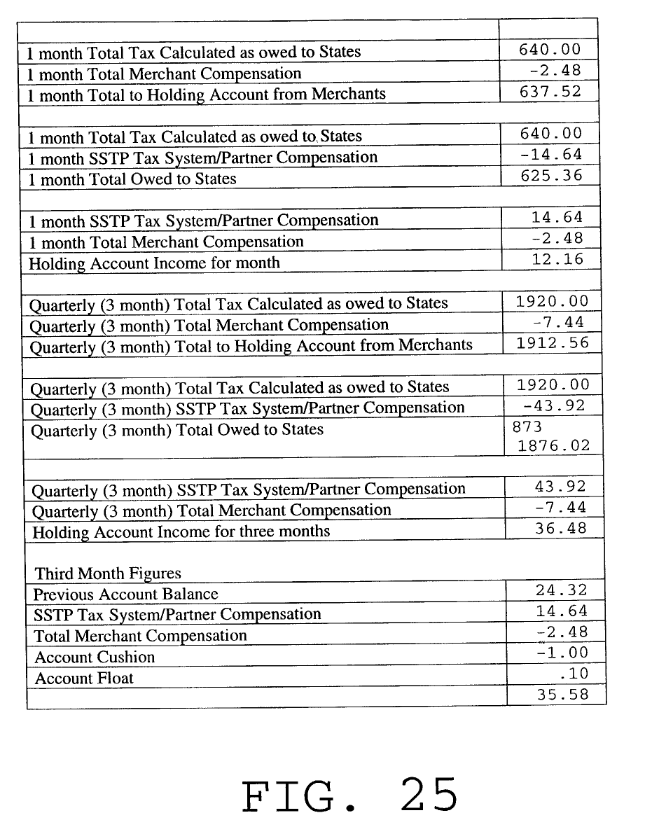

FIG. 24 shows table of taxes owed to taxing authorities and the associated fees paid to the Tax System Operator and 3rd party contractors and the resulting final payments to the taxing authorities according to the above examples. FIG. 25 is a table of monthly and quarterly figures for merchant compensation, Tax System Operator compensation, 3rd party compensation and taxes paid to taxing authorities according to the examples above.

Compensation Tax System Operator and 3^{rd} Party Contractors

Tax System Compensation=60%

60% of 35.58=21.35

Partner Compensation=40%

40% of 35.58=14.23

Financial Reporting

This section describes the data elements that must be reported relative to the financial flow for each of the entities using the Tax System 1150.

Tax System 1150 Financial Reporting requires that reports be produced for each of four entities: Merchants, taxing authorities, the Tax System Operator, and 3^{rd} party contractors.

For each merchant for each taxing authority the total amount of Tax System 1150 calculated taxes (net amount—debit minus credit amounts) is calculated and displayed.

For each merchant for each taxing authority an itemized list of activity relative to merchant compensation is produced. Merchants may receive two types of compensation: 1) retention of vendor discounts for states allowing such discounts, and 2) a by-contract percentage of Tax System Operator compensation.

For each merchant where compensation formula includes any or all of the above two categories, the base upon which the compensation amount was calculated as well as the calculated amount of compensation taxes (net amount—debit minus credit amounts) is displayed.

For each merchant for each taxing authority the total amount of tax money to be remitted is displayed as the total amount of the Tax System 1150 calculated taxes (net amount—debit minus credit amounts minus the total amount of merchant compensation) for each taxing authority. This is shown in the sample reports to merchants shown in FIGS. 19-22.

For each merchant for all taxing authority, the total amount of tax money to be remitted is displayed as the total amount of the Tax System 1150 calculated taxes (net amount—debit minus credit amounts) minus the total amount of merchant compensation (net amount—debit minus credit amounts). This is shown in the sample reports to merchants shown in FIGS. 19-22.

The message that triggers the amount of money to be transferred from the Merchant Account 1152 to the Tax System Holding Account 1156 is the balance calculated in item 5 above.

For each taxing authority for all merchants, the total tax calculated by the Tax System 1150 (net amount—debit minus credit amounts) is displayed.

For each taxing authority for all merchants, the total new tax (net amount—debit minus credit amounts) calculated by the Tax System 1150 is displayed.

For each taxing authority for all merchants, Tax System 1150 compensation relative to collection of new tax amounts is calculated as the net amount which is debit minus credit amounts. In addition there is 5% compensation for new tax collected for WI; and 6% compensation for new tax collected for KS, NC, MI.

For each taxing authority for all merchants, the total number of finalized transactions processed by the Tax System 1150 is displayed, including debits and credits.

For each taxing authority for all merchants, the Tax System 1150 compensation based upon $0.03 per transaction is calculated and displayed. For each taxing authority for all merchants the sum of items 4 and 5 is displayed. For each taxing authority for all merchants the value of item 6 is compared to the value of item 2. Tax System Operator compensation is item 6 if the value of item 6 is not greater than that of item 2. Tax System Operator compensation is item 2 if the value of item 6 is greater than that of item 2. For each taxing authority for all merchants, the Total Tax Calculated amount as described in item 1 is displayed. For each taxing authority for all merchants, the System Operator Compensation amount as described in item 7 is displayed as a negative value. For each taxing authority for all merchants, the sum of items 8 and 9 is displayed as the amount of tax money to transfer to the taxing authorities.

Tax System/Partner Reporting

For stipulated contract period for each taxing authority for all Merchants, the total Tax calculated (net amount—debit minus credit amounts) as owed to taxing authorities is displayed.

For stipulated contract period for each taxing authority, the total Merchant Compensation (net amount—debit minus credit amounts) as a negative value is displayed.

For stipulated contract period for each taxing authority, the total amount to the Tax System Holding Account 1156 (item 1 above minus item 2 above) is deposited.

For stipulated contract period, the starting Tax System Holding Account 1156 balance [the amount of last period's Tax System Operator Compensation (item 7 under taxing authority Reporting), minus last period's merchant compensation, minus last period's account cushion, plus last period's account float] is displayed.

For stipulated contract period for each taxing authority, the amount of tax transferred to taxing authority accounts as described in item 10 under taxing authority reporting is displayed as a negative value.

For stipulated contract period for each taxing authority for all merchant activity, the amount of calculated Tax System Operator Compensation as described in item 7 under taxing authority reporting is displayed as a positive value.

For the Tax System Holding Account 1156, the amount of cushion to be retained as a negative value is displayed.

For the Tax System Holding Account 1156, the amount of float income for the stipulated contract period is displayed as a positive value.

Sum values are represented in items 1-5 above.

The contract Tax System Operator/3^{rd} Party contractor percentage distribution is applied to the amount in item 6.

The amount owed to the Tax System Operator and its 3^{rd} Party contractor as determined in item 7 is the amount sent to the 3^{rd} party requesting funds transfer from the Tax System Holding Account 1156 to the Tax System Depository Account 1160 and 3^{rd} Party Depository Account 158.

A computer system with which the various elements of the tax transaction system of FIG. 1 and/or FIG. 14 may be implemented either individually or in combination typically includes at least one main unit connected to both an output device which displays information to a user and an input device which receives input from a user. The main unit may include a processor connected to a memory system via an interconnection mechanism. The input devices also are connected to the processor and memory system via the interconnection mechanism.

One or more output devices may be connected to the computer system. Example output devices include cathode ray tube (CRT) displays, liquid crystal displays (LCD), and other video output devices, printers, communication devices such as a modem, storage devices such as a disk or tape, and audio output, One or more input devices may be connected to the computer system. Example input devices include a keyboard, keypad, track ball, mouse, pen and tablet, communication device, and data input devices such as audio and video capture devices. The invention is not limited to the particular input or output devices used in combination with the computer system or to those described herein.

The computer system may be a general purpose computer system which is programmable using a computer programming language, such as C, C++, JAVA, or other language, such as a scripting language or even assembly language. The computer system may also be specially programmed, have special purpose hardware, or have an application specific integrated circuit (ASIC). The seller's device may also be a pager, telephone, personal digital assistant, or other electronic data communication device including a palm computing device.

In a general purpose computer system, the processor is typically a commercially available processor, of which the series IC86 and Pentium series processors, available from Intel, and similar devices from AMD and Cyrix, the 680×0 series microprocessors available from Motorola, the PowerPC microprocessor from IBM and the Alpha-series processors from the former Digital Equipment Corporation, and the MIPS microprocessor from MIPS Technologies are examples. Many other processors are available. Such a microprocessor executes a program called an operating system, of which WindowsNT, Windows 95 or 98, IRIX, UNIX, Linux, DOS, VMS, MacOS, and OS8 are examples, which controls the execution of other computer programs and provides scheduling, debugging, input/output control, accounting, compilation, storage assignment, data management, memory management, and communication control and related services. The processor and operating system define the computer platform for which application programs in high-level programming, languages are written.

A memory system typically includes a computer readable and writable nonvolatile recording medium, of which a magnetic disk, a flash memory, and tape are examples. The disk may be removable, known as a floppy disk, or permanent, known as a hard drive. A disk has a number of tracks in which signals are stored, typically in binary form, i.e., a form interpreted as a sequences of ones and zeros. Such signals may define an application program to be executed by the microprocessor, or information stored on the disk to be processed by the application program. Typically, in operation, the processor causes data to be read from the nonvolatile recording medium into an integrated circuit memory element, which is typically a volatile, random access memory, such as a dynamic random access memory (DRAM) or static memory (SRAM). The integrated circuit memory element allows for faster access to the information by the processor than does the disk. The processor generally manipulates the data within the integrated circuit memory and then copies the data to the disk after processing is completed. A variety of mechanisms are known for managing data movement between the disk and the integrated circuit memory element, and the invention is not limited thereto. The invention is not limited to a particular memory system.

Such a system may be implemented in software, hardware, or firmware, or any combination thereof The various elements of the system, either individually or in combination, may be implemented as computer program product tangibly embodied in a machine-readable storage device for execution by a computer processor.

Various steps of the process may be performed by a computer processor executing a program tangibly embodied on a computer-readable medium to perform functions by operating on input and generating output. Computer programming languages suitable for implementing such a system include procedural programming languages, object-oriented programming languages, and combinations of the two.

The invention is not limited to a particular computer platform, particular processor, or particular high-level programming language. Additionally, the computer system may be a multiprocessor computer system or may include multiple computers connected over a computer network. Various possible configurations of computers in a network permit many users to participate in a transaction, even if they are disbursed geographically.

Each module or step shown in the accompanying Figures and the substeps or subparts shown in the remaining Figures may correspond to separate modules of a computer program, or may be separate computer programs. Such modules may be operable on separate computers or other devices. The data produced by these components may be stored in a memory system or transmitted between computer systems or devices. The plurality of computers or devices may be interconnected by a communication network, such as a public switched telephone network or other circuit switched network, or a packet switched network such as an Internet protocol (IP) network.

The network may be wired or wireless, and may be public or private.

Having now described a few embodiments, it should be apparent to those skilled in the art that the foregoing is merely illustrative and not limiting, having been presented by way of example only. Numerous modifications and other embodiments may be made. For example, the tax transaction system may be applied to any type of tax which must be collected and remitted, including, but not limited to telecommunications, transportation, utilities, and other transaction taxes.

What is claimed is:

1. A method for managing a tax transaction, comprising the steps of:
a) accessing a transaction tax compliance processor having at least one selling/purchasing system at a remote location;
b) receiving and sending transaction information from the at least one system to said processor;
c) calculating an applicable tax liability by said processor; and
d) transferring funds from a retailer account associated with said at least one selling/purchasing system to a transaction tax compliance account in response to said calculated tax liability.

2. The method of claim 1 wherein accessing the transaction tax compliance processor and calculating the applicable tax liability are accomplished in real-time.

3. The method of claim 1 wherein transferring funds from said retailer account to said transaction compliance account is performed in a periodic batch transaction.

4. The method of claim 1 wherein accessing the transaction tax compliance processor, sending the transaction information, and transferring funds from a retailer account to a transaction tax compliance account are accomplished over a global computer network.

5. The method of claim 2 wherein the applicable tax liability includes at least one of international taxes, federal taxes, state or provincial taxes and local taxes.

6. The method of claim 1 further comprising the step of calculating fees due to a maintainer of said transaction tax compliance processor according to a maintainer percentage of said calculated tax liability.

7. The method of claim 6 further comprising the step of calculating a tax amount due to a tax authority according to said calculated tax liability and said maintainer percentage.

8. The method of claim 7 further comprising the steps of:
calculating a plurality of applicable tax liabilities, and
calculating amounts due to a plurality of tax authorities according to said calculated tax liabilities and said maintainer percentage.

9. The method of claim 7 further comprising the step of transferring funds according to said calculated tax amount from said transaction tax compliance account to a tax authority account.

10. The method of claim 8 further comprising the step of transferring funds according to said calculated amounts from said transaction tax compliance account to a plurality of tax authority accounts.

11. A system for managing a tax transaction, comprising:
a) means for assessing a transaction tax compliance processor having at least one selling/purchasing system at a remote location;
b) means for receiving and sending transaction information from the at least one system to said processor;
c) means for calculating an applicable tax liability by said processor; and
d) means for transferring funds from a retailer account to a transaction tax compliance account in response to said calculated tax liability.

12. The system of claim 11 further comprising means for calculating fees due to a maintainer of said transaction tax compliance processor according to a maintainer percentage of said calculated tax liability.

13. The system of claim 12 further comprising means for calculating a tax amount due to a tax authority according to said calculated tax liability and said maintainer percentage.

14. The system of claim 13 further comprising:
means for calculating a plurality of applicable tax liabilities, and
means for calculating amounts due to a plurality of tax authorities according to said calculated tax liabilities and said maintainer percentage.

15. The system of claim 13 further comprising means for transferring funds according to said calculated tax amount from said transaction tax compliance account to a tax authority account.

16. The system of claim 14 further comprising means for transferring funds according to said calculated amounts from said transaction tax compliance account to a plurality of tax authority accounts.

17. A method for managing a tax transaction, comprising the steps of:
a) accessing a transaction tax compliance processor having at least one selling/purchasing system at a remote location;
b) receiving and sending transaction information from the at least one system to said processor;
c) calculating an applicable tax liability by said processor;
d) transferring funds through a third party from a retailer to a tax authority in response to said calculated tax liability.

18. The method of claim 17 wherein an audit file is used to calculate said applicable tax liability.

19. The method of claim 17 wherein said transferring funds step further comprises the step of notifying a retailer by said third party of a date and amount for said funds transfer.

20. The method of claim 19 wherein said transferring funds step further comprises the step of debiting by said third party said amount from a retailer account and depositing said amount in a tax system holding account.

21. The method of claim 20 wherein said transferring funds step further comprises the step of calculating fees due said third party and a maintainer of said tax processor.

22. The method of claim 21 wherein said step of calculating fees further comprises calculating fees as a percentage of said applicable tax liability.

23. The method of claim 21 further comprising the steps of transferring a third party fee to a third party deposit account, and transferring a maintainer fee to a tax system deposit account.

24. The method of claim 20 further comprising the step of calculating a tax due and transferring said tax to a state account.

25. The method of claim 17 further comprising the step of compensating said retailer based on at least one of the following factors: per transaction fee, merchant discount, and tax system percentage incentive.

26. The method of claim 17 further comprising the step of compensating the tax system maintainer with float from a retailer account.

27. A method for managing a tax transaction, comprising the steps of:
a) accessing a transaction tax compliance processor having at least one selling/purchasing system at a remote location;
b) receiving and sending transaction information from the at least one system to said processor;
c) calculating an applicable tax liability by said processor;
d) transferring funds from a retailer account to a transaction tax compliance account in response to said calculated tax liability;
e) calculating fees due to a maintainer according to a defined portion of said calculated tax liability;
f) calculating amount due to a tax authority after fees due to the tax compliance system; and
g) transferring funds to said tax authority in response to said calculated amount.
